(19) United States
(12) Patent Application Publication
(10) Pub. No.: US 2022/0397742 A1
(43) Pub. Date: Dec. 15, 2022

(54) Optical Imaging Camera Lens Assembly

(71) Applicant: ZHEJIANG SUNNY OPTICS CO.,LTD., Ningbo (CN)

(72) Inventors: Shuang ZHANG, Ningbo (CN); Xiaobin ZHANG, Ningbo (CN); Jianke WENREN, Ningbo (CN); Fujian DAI, Ningbo (CN); Liefeng ZHAO, Ningbo (CN)

(21) Appl. No.: 17/828,060

(22) Filed: May 31, 2022

(30) Foreign Application Priority Data
Jun. 4, 2021 (CN) 202110624976.6

(51) Int. Cl. G02B 9/64; G02B 13/00

(52) U.S. Cl. CPC G02B 9/64; G02B 13/0045

(57) ABSTRACT

The disclosure provides an optical imaging camera lens assembly, sequentially including, from an object side to an image side along an optical axis: a first lens having a positive refractive power; a second lens, an object-side surface thereof being a convex surface, and an image-side surface thereof being a concave surface; a third lens having a negative refractive power, and an object-side surface thereof being a convex surface; a fourth lens; a fifth lens having a negative refractive power; a sixth lens having a positive refractive power; and a seventh lens having a negative refractive power, wherein ImgH is a half of a diagonal length of an effective pixel region on an imaging surface, and TTL is an on-axis distance from the object-side surface of the first lens to the imaging surface, ImgH and TTL satisfy: 4.8 mm<ImgH*ImgH/TTL<7.0 mm; an Abbe number V1 of the first lens satisfies: 70<V1<90.

### CROSS-REFERENCE TO RELATED PRESENT INVENTION(S)

The disclosure claims priority to and the benefit of Chinese Patent Present invention No. 202110624976.6, filed in the China National Intellectual Property Administration (CNIPA) on 4 Jun. 2021, which is incorporated herein by reference in its entirety.

### TECHNICAL FIELD

The disclosure relates to the technical field of optical imaging, and in particular to an optical imaging camera lens assembly including seven lenses.

### BACKGROUND

With the rapid development of camera devices and the white hot trend in the development of mobile phone photography in the market, mobile phones equipped with high-pixel imaging camera lenses have almost reached a norm state in the industry. While pursuing high-pixel imaging, the requirements of major manufacturers for image quality on image surfaces have reached new heights with the development of science and technology and industrial technology. That is, while designing high-pixel imaging camera lenses, the major manufacturers put forward more stringent requirements for a purple fringing phenomenon during a shooting process of the camera lenses.

Therefore, the disclosure provides a novel optical imaging camera lens assembly, so as to alleviate the problem of purple fringing during the shooting process of high-pixel mobile phones, by improving the material of a first lens, improving the Abbe number, and optimizing and perfecting the chromatic aberration of the system.

### SUMMARY

Some embodiments of the disclosure provide an optical imaging camera lens assembly composed of seven lenses, which has the characteristics of compact structure and high pixels, and can well correct magnification chromatic aberration, and optimize and weaken a purple fringing phenomenon during a shooting process of the camera lens.

The disclosure provides an optical imaging camera lens assembly, sequentially including, from an object side to an image side along an optical axis: a first lens having a positive refractive power; a second lens, an object-side surface thereof being a convex surface, and an image-side surface thereof being a concave surface; a third lens having a negative refractive power, and the object-side surface thereof being a convex surface; a fourth lens; a fifth lens having a negative refractive power; a sixth lens having a positive refractive power; and a seventh lens having a negative refractive power,

wherein ImgH is a half of a diagonal length of an effective pixel region on an imaging surface, and TTL is an on-axis distance from the object-side surface of the first lens to the imaging surface, ImgH and TTL satisfy: 4.8 mm<ImgH*ImgH/TTL<7.0 mm; and an Abbe number V1 of the first lens satisfies: 70<V1<90.

According to one embodiment of the disclosure, ImgH and TTL satisfy: TTL/ImgH<1.3.

According to one embodiment of the disclosure, FOV is a maximum field of view of the optical imaging camera lens assembly, an effective focal length f of the optical imaging camera lens assembly and FOV satisfy: 5.5 mm<f*tan (FOV/2)<6.5 mm.

According to one embodiment of the disclosure, a curvature radius R1 of the object-side surface of the first lens, the curvature radius R2 of the image-side surface of the first lens, and the effective focal length f1 of the first lens satisfy: 1.0<(R1+R2)/f1<1.5.

According to one embodiment of the disclosure, the effective focal length f4 of the fourth lens and the effective focal length f6 of the sixth lens satisfy: 1.5<(f4+f6)/(f4−f6)<2.0.

According to one embodiment of the disclosure, the curvature radius R6 of the image-side surface of the third lens, the curvature radius R5 of the object-side surface of the third lens, and the effective focal length f3 of the third lens satisfy: 1.6<f3/(R6−R5)<4.2.

According to one embodiment of the disclosure, the effective focal length f5 of the fifth lens and the effective focal length f7 of the seventh lens satisfy: 2.5<f5/f7<4.6.

According to one embodiment of the disclosure, the curvature radius R11 of the object-side surface of the sixth lens, the curvature radius R12 of the image-side surface of the sixth lens, the curvature radius R13 of the object-side surface of the seventh lens, and the curvature radius R14 of the image-side surface of the seventh lens satisfy: 0<(R11+R12)/(R13+R14)<1.5.

According to one embodiment of the disclosure, a combined focal length f12 of the first lens and the second lens, and the combined focal length f56 of the fifth lens and the sixth lens satisfy: 0.7<f12/f56<1.2.

According to one embodiment of the disclosure, the on-axis distance SAG51 from an intersection point of the object-side surface of the fifth lens and the optical axis to an effective radius vertex of the object-side surface of the fifth lens, the on-axis distance SAG52 from the intersection point of the image-side surface of the fifth lens and the optical axis to the effective radius vertex of the image-side surface of the fifth lens, the on-axis distance SAG61 from the intersection point of the object-side surface of the sixth lens and the optical axis to the effective radius vertex of the object-side surface of the sixth lens, and the on-axis distance SAG62 from the intersection point of the image-side surface of the sixth lens and the optical axis to the effective radius vertex of the image-side surface of the sixth lens satisfy: 0.7<(SAG51+SAG52)/(SAG61+SAG62)<1.2.

According to one embodiment of the disclosure, the on-axis distance SAG71 from the intersection point of the object-side surface of the seventh lens and the optical axis to the effective radius vertex of the object-side surface of the seventh lens, the on-axis distance SAG72 from the intersection point of the image-side surface of the seventh lens and the optical axis to the effective radius vertex of the image-side surface of the seventh lens, and an air spacing T67 between the sixth lens and the seventh lens on the optical axis satisfy: −2.7<(SAG71+SAG72)/T67<−2.2.

According to one embodiment of the disclosure, a center thickness CT3 of the third lens on the optical axis, an edge thickness ET3 of the third lens, the center thickness CT4 of the fourth lens on the optical axis, and the edge thickness ET4 of the fourth lens satisfy: 0.7<(CT3+ET3)/(CT4+ET4)<1.1.

According to one embodiment of the disclosure, the edge thickness ET5 of the fifth lens, the edge thickness ET6 of the sixth lens, and the edge thickness ET7 of the seventh lens satisfy: 1.6<(ET5+ET6)/ET7<2.1.

The disclosure has beneficial effects as follows:

The optical imaging camera lens assembly provided by the disclosure includes a plurality of lenses, such as the first lens to the seventh lens. The first lens having the positive refractive power has a converging effect on light, the converged light passes through the second lens, thereof the object-side surface is the convex surface and the image-side surface is the concave surface, which is conducive to the smooth transmission of the light, and is also conducive to the optimization of spherical aberration. The third lens having the negative refractive power and the object side thereof being the convex surface is conducive to balancing the refractive power of an optical system. The light is dispersed by the fifth lens having the negative refractive power, then is converged by the sixth lens having the positive refractive power, and is finally output by the seventh lens having a divergence effect. By reasonably allocating the refractive power of the seven lenses, stable transmission of the light is ensured, such that the optical system has a compact structure and high pixels. The optical system that satisfies a conditional formula 4.8 mm<ImgH*ImgH/TTL<7.0 mm has the characteristics of having an ultra-thin and large image surface, well correcting the magnification chromatic aberration, and optimizing and weakening the purple fringing phenomenon during the shooting process of the camera lens.

### BRIEF DESCRIPTION OF THE DRAWINGS

To illustrate technical solutions in the embodiments of the disclosure more clearly, a brief introduction on the drawings which are needed in the description of the embodiments is given below. Apparently, the drawings in the description below are merely some of the embodiments of the disclosure, based on which other drawings can be obtained by those of ordinary skill in the art without any creative effort.

FIG. 1 shows schematic structural diagram of a lens group in Embodiment 1 of an optical imaging camera lens assembly according to the disclosure;

FIG. 2a to FIG. 2d respectively show a longitudinal aberration curve, an astigmatism curve, a distortion curve and a lateral color curve in Embodiment 1 of the optical imaging camera lens assembly according to the disclosure;

FIG. 3 shows schematic structural diagram of a lens group in Embodiment 2 of the optical imaging camera lens assembly according to the disclosure;

FIG. 4a to FIG. 4d respectively show a longitudinal aberration curve, an astigmatism curve, a distortion curve and a lateral color curve in Embodiment 2 of the optical imaging camera lens assembly according to the disclosure;

FIG. 5 shows schematic structural diagram of a lens group in Embodiment 3 of the optical imaging camera lens assembly according to the disclosure;

FIG. 6a to FIG. 6d respectively show a longitudinal aberration curve, an astigmatism curve, a distortion curve and a lateral color curve in Embodiment 3 of the optical imaging camera lens assembly according to the disclosure;

FIG. 7 shows schematic structural diagram of a lens group in Embodiment 4 of the optical imaging camera lens assembly according to the disclosure;

FIG. 8a to FIG. 8d respectively show a longitudinal aberration curve, an astigmatism curve, a distortion curve and a lateral color curve in Embodiment 4 of the optical imaging camera lens assembly according to the disclosure;

FIG. 9 shows schematic structural diagram of a lens group in Embodiment 5 of the optical imaging camera lens assembly according to the disclosure;

FIG. 10a to FIG. 10d respectively show a longitudinal aberration curve, an astigmatism curve, a distortion curve and a lateral color curve in Embodiment 5 of the optical imaging camera lens assembly according to the disclosure;

FIG. 11 shows schematic structural diagram of a lens group in Embodiment 6 of the optical imaging camera lens assembly according to the disclosure;

FIG. 12a to FIG. 12d respectively show a longitudinal aberration curve, an astigmatism curve, a distortion curve and a lateral color curve in Embodiment 6 of the optical imaging camera lens assembly according to the disclosure;

FIG. 13 shows schematic structural diagram of a lens group in Embodiment 7 of the optical imaging camera lens assembly according to the disclosure;

FIG. 14a to FIG. 14d respectively show a longitudinal aberration curve, an astigmatism curve, a distortion curve and a lateral color curve in Embodiment 7 of the optical imaging camera lens assembly according to the disclosure;

FIG. 15 shows schematic structural diagram of a lens group in Embodiment 8 of the optical imaging camera lens assembly according to the disclosure;

FIG. 16a to FIG. 16d respectively show a longitudinal aberration curve, an astigmatism curve, a distortion curve and a lateral color curve in Embodiment 8 of the optical imaging camera lens assembly according to the disclosure;

FIG. 17 shows schematic structural diagram of a lens group in Embodiment 9 of the optical imaging camera lens assembly according to the disclosure; and

FIG. 18a to FIG. 18d respectively show a longitudinal aberration curve, an astigmatism curve, a distortion curve and a lateral color curve in Embodiment 9 of the optical imaging camera lens assembly according to the disclosure.

### DETAILED DESCRIPTION OF THE EMBODIMENTS

A clear and complete description of technical solutions in the embodiments of the disclosure will be given below, in combination with the drawings in the embodiments of the disclosure. Apparently, the embodiments described below are merely a part, but not all, of the embodiments of the disclosure. All of other embodiments, obtained by those of ordinary skill in the art based on the embodiments of the disclosure without any creative effort, fall into the protection scope of the disclosures.

It should be noted that in the present specification, the expressions of first, second, third and the like are only used for distinguishing one feature from another feature, but do not imply any limitation on the feature. Accordingly, without departing from the teachings of the disclosure, a first lens discussed below can also be referred to as a second lens or a third lens.

It should also be further understood that, the terms “contain,” “containing,” “having,” “includes” and/or “including”, when used in the present specification, indicate the presence of stated features, elements and/or components, but do not preclude the presence or addition of one or more other features, elements, components, and/or combinations thereof. In addition, when a statement such as “at least one of” appears after a list of listed features, it modifies the entire listed feature and not an individual element in the list. In addition, when the embodiments of the disclosure are described, “may” is used for expressing “one or more embodiments of the disclosure”. Furthermore, the term “exemplary” is intended to refer to an example or illustration.

In the drawings, for the convenience of illustration, the thickness, size and shape of the lens have been slightly exaggerated. Specifically, spherical or aspheric shapes shown in the drawings are shown by way of examples. That is, the spherical or aspheric shapes are not limited to the spherical or aspheric shapes shown in the drawings. The drawings are examples only and are not drawn strictly to scale.

In the description of the disclosure, a paraxial region refers to an region in the vicinity of an optical axis. If a lens surface is a convex surface and the position of the convex surface is not defined, it means that the lens surface is a convex surface at least in the paraxial region; and if the lens surface is a concave surface and the position of the concave surface is not defined, it means that the lens surface is a concave surface at least in the paraxial region. A surface of each lens closest to a photographed object is called an object-side surface of the lens, and a surface of each lens closest to an imaging surface is called an image-side surface of the lens.

Unless otherwise defined, all terms (including technical and scientific terms) used herein have the same meaning as commonly understood by those of ordinary skill in the art to which the disclosure belongs. It should also be understood that, the terms (such as those defined in commonly used dictionaries) should be interpreted as having the same meanings as those in the context of a related art, and will not be interpreted in an idealized or overly formal sense, unless expressly so defined herein.

It should be noted that, if there is no conflict, embodiments in the disclosure and features in the embodiments can be combined with each other. Hereinafter, the features, principles and other aspects of the disclosure will be described in detail below with reference to the drawings and in conjunction with the embodiments.

### EXEMPLARY EMBODIMENTS

An optical imaging camera lens assembly in an exemplary embodiment of the disclosure includes seven lenses, which sequentially include, from an object side to an image side along an optical axis: a first lens, a second lens, a third lens, a fourth lens, a fifth lens, a sixth lens and a seventh lens, wherein the lenses are independent of each other, and there are air spacings among the lenses on the optical axis.

In the present exemplary embodiment, the optical imaging camera lens assembly includes: a first lens having a positive refractive power; a second lens, an object-side surface thereof being a convex surface, and an image-side surface thereof being a concave surface; a third lens having a negative refractive power, and the object-side surface thereof being a convex surface; a fourth lens; a fifth lens having a negative refractive power; a sixth lens having a positive refractive power; and a seventh lens having a negative refractive power.

The first lens having the positive refractive power has a converging effect on light, the converged light passes through the second lens, in which the object side is the convex surface and the image side is the concave surface, which is conducive to the smooth transmission of the light, and is also conducive to the optimization of spherical aberration. The third lens having the negative refractive power and the object side thereof being the convex surface is conducive to balancing the refractive power of an optical system. The light is dispersed by the fifth lens having the negative refractive power, then is converged by the sixth lens having the positive refractive power, and is finally output by the seventh lens having a divergence effect. By reasonably allocating the refractive power of the seven lenses, stable transmission of the light is ensured, such that the system has the characteristics of compact structure and high pixels.

In the present exemplary embodiment, ImgH is a half of a diagonal length of an effective pixel region on an imaging surface, and TTL is an on-axis distance from the object-side surface of the first lens to the imaging surface, ImgH and TTL satisfy: 4.8 mm<ImgH*ImgH/TTL<7.0 mm. The system that satisfies a conditional formula 4.8 mm<ImgH*ImgH/TTL<7.0 mm has the characteristics of an ultra-thin and large image surface. More specifically, ImgH and TTL satisfy: 5.0 mm<ImgH*ImgH/TTL<6.0 mm.

In the present exemplary embodiment, an Abbe number V1 of the first lens satisfies: 70<V1<90. The system that simultaneously satisfies the conditional formula 70<V1<90 can well correct magnification chromatic aberration, and optimize and weaken a purple fringing phenomenon during a shooting process of the camera lens. More specifically, the Abbe number V1 of the first lens satisfies: 80<V1<87.

In the present exemplary embodiment, ImgH is a half of a diagonal length of an effective pixel region on an imaging surface, and TTL is an on-axis distance from the object-side surface of the first lens to the imaging surface, ImgH and TTL satisfy: TTL/ImgH<1.3. The system satisfying the conditional formula has the characteristics of ultra-thinness and portable structure, and the length of a module is greatly reduced. More specifically, ImgH and TTL satisfy: TTL/ImgH<1.27.

In the present exemplary embodiment, FOV is a maximum field of view of the optical imaging camera lens assembly, an effective focal length f of the optical imaging camera lens assembly and FOV satisfy: 5.5 mm<f*tan (FOV/2)<6.5 mm. The system satisfying the conditional formula has the characteristics of large image surface, and improves the pixels of a photographed picture. More specifically, the effective focal length f of the optical imaging camera lens assembly and FOV satisfy: 5.5 mm<f*tan (FOV/2)<6.25 mm.

In the present exemplary embodiment, a curvature radius R1 of the object-side surface of the first lens, the curvature radius R2 of the image-side surface of the first lens, and the effective focal length f1 of the first lens satisfy: 1.0<(R1+R2)/f1<1.5. By controlling the shape of the first lens, the MTF performance of the optical system can be improved. More specifically, the curvature radius R1 of the object-side surface of the first lens, the curvature radius R2 of the image-side surface of the first lens, and the effective focal length f1 of the first lens satisfy: 1.10<(R1+R2)/f1<1.35.

In the present exemplary embodiment, the effective focal length f4 of the fourth lens and the effective focal length f6 of the sixth lens satisfy: 1.5<(f4+f6)/(f4−f6)<2.0. By reasonably controlling the refractive power of the fourth lens and the sixth lens, the astigmatism of the system can be optimized. More specifically, the effective focal length f4 of the fourth lens and the effective focal length f6 of the sixth lens satisfy: 1.60<(f4+f6)/(f446)<1.9.

In the present exemplary embodiment, the curvature radius R6 of the image-side surface of the third lens, the curvature radius R5 of the object-side surface of the third lens, and the effective focal length f3 of the third lens satisfy: 1.6<f3/(R6−R5)<4.2. By comprehensively allocating the refractive power of the third lens and controlling the shape of the third lens, it is beneficial to optimizing the chromatic aberration of the system and balancing the field curvature of the system. More specifically, the curvature radius R6 of the image-side surface of the third lens, the curvature radius R5 of the object-side surface of the third lens, and the effective focal length f3 of the third lens satisfy: 1.70<f3/(R6−R5)<4.10.

In the present exemplary embodiment, the effective focal length f5 of the fifth lens and the effective focal length f7 of the seventh lens satisfy: 2.5<f5/f7<4.6. By allocating the relationship between the refractive power of the fifth lens and the seventh lens, the field curvature of the system is balanced and optimized, and at the same time, it is conducive to improving the phenomenon of stray light at a tail end of the system. More specifically, the effective focal length f5 of the fifth lens and the effective focal length f7 of the seventh lens satisfy: 2.6<f5/f7<4.5.

In the present exemplary embodiment, the curvature radius R11 of the object-side surface of the sixth lens, the curvature radius R12 of the image-side surface of the sixth lens, the curvature radius R13 of the object-side surface of the seventh lens, and the curvature radius R14 of the image-side surface of the seventh lens satisfy: 0<(R11+R12)/(R13+R14)<1.5. By optimizing the shapes of the sixth lens and the seventh lens, the astigmatism of the system can be corrected, and the process performance of the system can be enhanced, which is beneficial to subsequent lens processing. More specifically, the curvature radius R11 of the object-side surface of the sixth lens, the curvature radius R12 of the image-side surface of the sixth lens, the curvature radius R13 of the object-side surface of the seventh lens, and the curvature radius R14 of the image-side surface of the seventh lens satisfy: 0.3<(R11+R12)/(R13+R14)<1.20.

In the present exemplary embodiment, a combined focal length f12 of the first lens and the second lens, and the combined focal length f56 of the fifth lens and the sixth lens satisfy: 0.7<f12/f56<1.2. By allocating the relationship between the synthetic refractive power of the first two lenses and the synthetic refractive power of the fifth and sixth lenses, it is beneficial to balancing the field curvature while optimizing the MTF performance of the system, and correcting spherical aberration, chromatic aberration and other performance. More specifically, the combined focal length f12 of the first lens and the second lens, and the combined focal length f56 of the fifth lens and the sixth lens satisfy: 0.8<f12/f56<1.1.

In the present exemplary embodiment, the on-axis distance SAG51 from an intersection point of the object-side surface of the fifth lens and the optical axis to an effective radius vertex of the object-side surface of the fifth lens, the on-axis distance SAG52 from the intersection point of the image-side surface of the fifth lens and the optical axis to the effective radius vertex of the image-side surface of the fifth lens, the on-axis distance SAG61 from the intersection point of the object-side surface of the sixth lens and the optical axis to the effective radius vertex of the object-side surface of the sixth lens, and the on-axis distance SAG62 from the intersection point of the image-side surface of the sixth lens and the optical axis to the effective radius vertex of the image-side surface of the sixth lens satisfy: 0.7<(SAG51+SAG52)/(SAG61+SAG62)<1.2. By controlling a vector height relationship between the fifth lens and the sixth lens, the shapes of the fifth lens and the sixth lens are optimized, which is beneficial to the lens processing, and meanwhile, it is beneficial to balancing the optical aberration of the system. More specifically, the on-axis distance SAG51 from the intersection point of the object-side surface of the fifth lens and the optical axis to the effective radius vertex of the object-side surface of the fifth lens, the on-axis distance SAG52 from the intersection point of the image-side surface of the fifth lens and the optical axis to the effective radius vertex of the image-side surface of the fifth lens, the on-axis distance SAG61 from the intersection point of the object-side surface of the sixth lens and the optical axis to the effective radius vertex of the object-side surface of the sixth lens, and the on-axis distance SAG62 from the intersection point of the image-side surface of the sixth lens and the optical axis to the effective radius vertex of the image-side surface of the sixth lens satisfy: 0.9<(SAG51+SAG52)/(SAG61+SAG62)<1.1.

In the present exemplary embodiment, the on-axis distance SAG71 from the intersection point of the object-side surface of the seventh lens and the optical axis to the effective radius vertex of the object-side surface of the seventh lens, the on-axis distance SAG72 from the intersection point of the image-side surface of the seventh lens and the optical axis to the effective radius vertex of the image-side surface of the seventh lens, and an air spacing T67 between the sixth lens and the seventh lens on the optical axis satisfy: −2.7<(SAG71+SAG72)/T67<−2.2. A vector height of the seventh lens can be controlled, the relationship between the vector height and the gap of the sixth lens and the seventh lens is constrained at the same time, and the field curvature of the system is optimized by comprehensively controlling the shapes and the gaps of the lenses. More specifically, the on-axis distance SAG71 from the intersection point of the object-side surface of the seventh lens and the optical axis to the effective radius vertex of the object-side surface of the seventh lens, the on-axis distance SAG72 from the intersection point of the image-side surface of the seventh lens and the optical axis to the effective radius vertex of the image-side surface of the seventh lens, and an air spacing T87 between the sixth lens and the seventh lens on the optical axis satisfy-−2.60<(SAG71+SAG72)/T67<−2.40.

In the present exemplary embodiment, a center thickness CT3 of the third lens on the optical axis, an edge thickness ET3 of the third lens, the center thickness CT4 of the fourth lens on the optical axis, and the edge thickness ET4 of the fourth lens satisfy: 0.7<(CT3+ET3)/(CT4+ET4)<1.1. By optimizing the condition, when the manufacturability of the lenses is guaranteed, it is also beneficial to optimizing and improving the performance of the system such as chromatic aberration, spherical aberration, field curvature and distortion. More specifically, the center thickness CT3 of the third lens on the optical axis, the edge thickness ET3 of the third lens, the center thickness CT4 of the fourth lens on the optical axis, and the edge thickness ET4 of the fourth lens satisfy: 0.80<(CT3+ET3)/(CT4+ET4)<1.0.

In the present exemplary embodiment, the edge thickness ET5 of the fifth lens, the edge thickness ET6 of the sixth lens, and the edge thickness ET7 of the seventh lens satisfy 1.6<(ET5+ET6)/ET7<2.1. By controlling the relationship between the edge thicknesses of the latter three lenses, it is beneficial to optimizing the performance of an external field of view on the basis of ensuring the manufacturability. More specifically, the edge thickness ET5 of the fifth lens, the edge thickness ET6 of the sixth lens, and the edge thickness ET7 of the seventh lens satisfy-1.70<(ET5+ET6)/ET7<2.0.

In the present exemplary embodiment, the object-side surface and the image-side surface of any one of the first lens E1 to the seventh lens E7 are both aspheric surfaces, and the surface shape x of each aspheric lens can be defined, but not limited to, by the following aspheric formula:

$$x = \frac{{ch}^{2}}{1 + \sqrt{1 - ( k + 1 ) {c}^{2} {h}^{2}}} + \sum {Aih}^{i} \qquad ( 1 )$$

wherein x represents, when an aspheric surface is located at a position with a height h along the optical axis direction, a distance vector height from the vertex of the aspheric surface; c represents a paraxial curvature of the aspheric surface, c=1/R (that is, the paraxial curvature c is a reciprocal of the curvature radius R in Table 1); k represents a conic coefficient; and Ai represents a correction coefficient of the i-th order of the aspheric surface.

In the present exemplary embodiment, the above optical imaging camera lens assembly can further include a diaphragm. The diaphragm can be arranged at a proper location as needed, for example, the diaphragm can be arranged between the object side and the first lens. Optionally, the above optical imaging camera lens assembly can further include an optical filter for correcting chromatic aberration and/or protective glass for protecting a photosensitive element that is located on the imaging surface.

The optical imaging camera lens assembly according to the above-mentioned embodiments of the disclosure can employ multiple lenses, such as the above seven lenses. By reasonably allocating the refractive power and the surface shapes of the lenses, the center thicknesses of the lenses, the on-axis distances between the lenses, and the like, the optical imaging camera lens assembly has a relatively large imaging surface, and has the characteristics of wide imaging range and high imaging quality. Furthermore, the ultra-thinness of a mobile phone is guaranteed.

In an exemplary embodiment, at least one of lens surfaces of the lenses is an aspheric lens surface, that is, at least one lens surface of the object-side surface of the first lens to the image-side surface of the seventh lens is an aspheric lens surface. An aspheric lens is characterized in that, from the center of the lens to the periphery of the lens, the curvature changes continuously. Unlike a spherical lens, which has a constant curvature from the center of the lens to the periphery of the lens, the aspheric lens has better curvature radius characteristics, and has the advantages of improving distorted optical aberration and astigmatic aberration. After the aspheric lens is used, the optical aberration that occurs during imaging can be eliminated as much as possible, thereby improving the imaging quality. Optionally, at least one of the object-side surface and the image-side surface of each of the first lens, the second lens, the third lens, the fourth lens, the fifth lens and the seventh lens is an aspheric lens surface. Optionally, the object-side surface and the image-side surface of each of the first lens, the second lens, the third lens, the fourth lens, the fifth lens and the seventh lens are both aspheric lens surfaces.

However, those skilled in the art should understand that, without departing from the technical solutions claimed by the disclosure, the number of lenses constituting the optical imaging camera lens assembly can be changed to obtain various results and advantages described in the present specification. For example, although seven lenses are described as an example in the embodiments, the optical imaging camera lens assembly is not limited to including seven lenses. As needed, the optical imaging camera lens assembly can also include other numbers of lenses.

The specific embodiments of the optical imaging camera lens assembly applicable to the above-mentioned embodiments will be further described below with reference to the drawings.

### Specific Embodiment 1

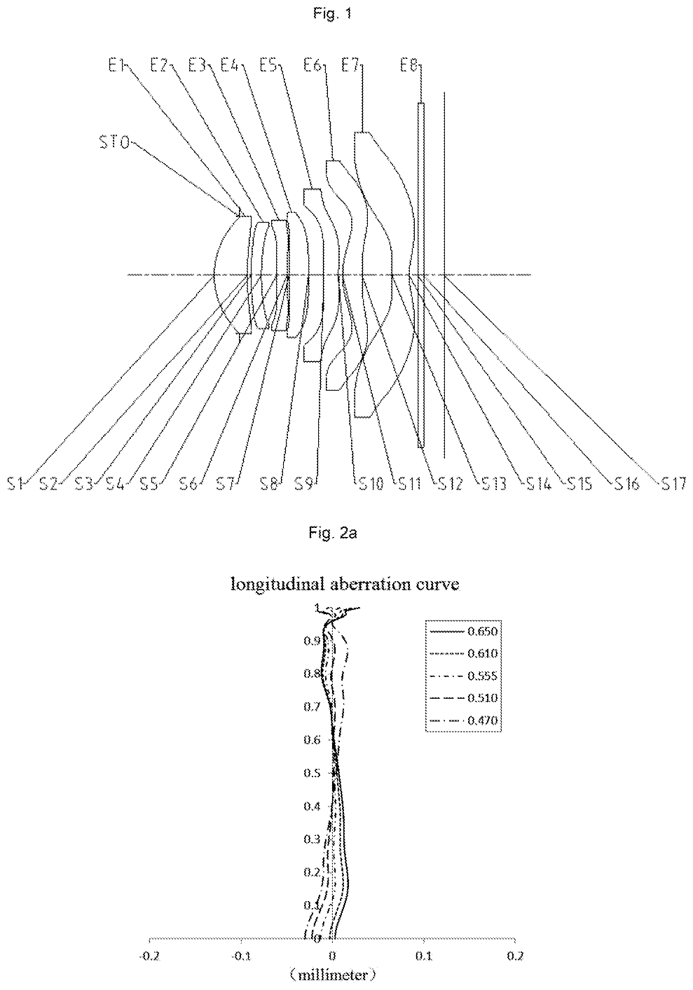

FIG. 1 is a schematic structural diagram of a lens group in Embodiment 1 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 1, it is a basic parameter table of the optical imaging camera lens assembly in Embodiment 1, wherein the units of curvature radius, thickness and focal length are all millimeters (mm).

TABLE 1

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 2000.0000 | | | | |
| STO | Spherical | Infinite | −0.8856 | | | | |
| S1 | Aspheric | 2.6976 | 1.1370 | 7.83 | 1.50 | 81.6 | −0.0402 |
| S2 | Aspheric | 7.5187 | 0.1280 | | | | −29.8629 |
| S3 | Aspheric | 6.9115 | 0.3600 | −102.24 | 1.67 | 19.2 | 2.4875 |
| S4 | Aspheric | 6.1523 | 0.5286 | | | | −1.8802 |
| S5 | Aspheric | 20.0262 | 0.3600 | −27.93 | 1.67 | 19.0 | −47.1852 |
| S6 | Aspheric | 9.6599 | 0.0687 | | | | −1.0000 |
| S7 | Aspheric | 21.2815 | 0.6754 | 22.25 | 1.54 | 56.0 | −44.3727 |
| S8 | Aspheric | −27.9327 | 0.5272 | | | | 31.1232 |
| S9 | Aspheric | 1650.0297 | 0.5038 | −13.01 | 1.57 | 37.3 | 80.0000 |
| S10 | Aspheric | 7.3851 | 0.1381 | | | | −6.8147 |
| 511 | Aspheric | 2.5382 | 0.6757 | 5.31 | 1.54 | 55.7 | −4.3481 |
| S12 | Aspheric | 21.0082 | 1.0349 | | | | 11.3608 |
| S13 | Aspheric | 20.3466 | 0.5900 | −4.89 | 1.54 | 55.7 | −12.0325 |
| S14 | Aspheric | 2.3017 | 0.2939 | | | | −1.0982 |
| S15 | Spherical | Infinite | 0.2100 | | 1.52 | 64.2 | |
| S16 | Spherical | Infinite | 0.6992 | | | | |
| S17 | Spherical | Infinite | | | | | |

As shown in Table 2, in Embodiment 1, a total effective focal length f of the optical imaging camera lens assembly is 6.50 mm, TTL is a distance on the optical axis from the object-side surface S1 of the first lens E1 to the imaging surface S17 of the optical imaging camera lens assembly, TTL is 7.93 mm, and ImgH is a half of a diagonal length of an effective pixel region on the imaging surface S17, ImgH is 6.33 mm.

TABLE 2
Embodiment 1

| | | | |
|---|---|---|---|
| f(mm) | 6.50 | TTL(mm) | 7.93 |
| ImgH(mm) | 6.33 | ImgH * ImgH/TTL(mm) | 5.05 |
| V1 | 81.61 | TTL/ImgH | 1.25 |
| f * tan(FOV/2)(mm) | 6.19 | (R1 + R2)/f1 | 1.30 |
| (f4 + f6)/(f4 − f6) | 1.63 | f3/(R6 − R5) | 2.69 |
| f5/f7 | 2.66 | (R11 + R12)/(R13 + R14) | 1.04 |
| f12/f56 | 0.92 | (SAG51 + SAG52)/ | 0.99 |
| | | (SAG61 + SAG62) | |
| (SAG71 + SAG72)/T67 | −2.56 | (CT3 + ET3)/(CT4 + ET4) | 0.87 |
| (ET5 + ET6)/ET7 | 1.95 | | |

The optical imaging camera lens assembly in Embodiment 1 satisfies:

ImgH*ImgH/TTL=5.05, wherein ImgH is the half of the diagonal length of the effective pixel region on the imaging surface, and TTL is an on-axis distance from the object-side surface of the first lens to the imaging surface.

V1=81.61, wherein V1 is an Abbe number of the first lens.

TTL/ImgH=1.25, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.30, wherein R1 is a curvature radius of the object-side surface of the first lens, R2 is the curvature radius of the image-side surface of the first lens, and f1 is the effective focal length of the first lens.

(f4+f6)/(f4−f6)=1.63, wherein f4 is the effective focal length of the fourth lens, and f6 is the effective focal length of the sixth lens.

f3/(R6−R5)=2.69, wherein R6 is the curvature radius of the image-side surface of the third lens, R5 is the curvature radius of the object-side surface of the third lens, and f3 is the effective focal length of the third lens.

f5/f7=2.66, wherein f5 is the effective focal length of the fifth lens, and f7 is the effective focal length of the seventh lens.

(R11+R12)/(R13+R14)=1.04, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=0.92, wherein f12 is a combined focal length of the first lens and the second lens, and f56 is the combined focal length of the fifth lens and the sixth lens.

(SAG51+SAG52)/(SAG61+SAG62)=0.99, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.56, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.87, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.95, wherein ET5 is the edge thickness of the fifth lens, ET6 is the edge thickness of the sixth lens, and ET7 is the edge thickness of the seventh lens.

In Embodiment 1, the object-side surface and the image-side surface of any one of the first lens E1 to the seventh lens E7 are both aspheric surfaces, and Table 3 shows high-order coefficients A4, A6, A8, A10, A12, A14, A16, A18, A20, A22, A24, A26, A28 and A30 that can be applied to various aspheric lens surfaces S1-S14 in Embodiment 1.

TABLE 3

| Surface number | A4 | A6 | A8 | A10 | A12 | A14 | A16 |
|---|---|---|---|---|---|---|---|
| S1 | −1.9545E−03 | 1.0208E−02 | −2.9437E−02 | 5.6002E−02 | −7.2897E−02 | 6.7225E−02 | −4.4943E−02 |
| S2 | −7.7013E−03 | 1.7674E−02 | −7.8176E−02 | 2.2863E−01 | −4.2576E−01 | 5.3237E−01 | −4.6309E−01 |
| S3 | −2.1425E−02 | 1.7141E−02 | −6.3855E−02 | 2.0858E−01 | −4.2842E−01 | 5.8656E−01 | −5.5646E−01 |
| S4 | −7.5753E−03 | −8.3306E−03 | 8.3351E−02 | −3.2662E−01 | 8.1459E−01 | −1.3643E+00 | 1.5857E+00 |
| S5 | −2.8715E−02 | 6.5335E−02 | −3.3926E−01 | 1.0712E+00 | −2.2553E+00 | 3.2997E+00 | −3.4403E+00 |
| S6 | −1.6106E−02 | −4.4599E−03 | −9.0466E−03 | 4.6073E−02 | −9.1744E−02 | 1.0952E−01 | −8.6274E−02 |
| S7 | −2.1076E−03 | −2.7860E−02 | 6.5296E−02 | −1.0638E−01 | 1.1781E−01 | −9.0057E−02 | 4.8254E−02 |
| S8 | −9.8025E−03 | −6.5855E−03 | 9.6357E−03 | −9.9878E−03 | 6.7173E−03 | −4.2073E−03 | 3.3049E−03 |
| S9 | −1.0718E−02 | −1.7702E−02 | 3.9157E−02 | −4.8066E−02 | 3.9597E−02 | −2.3742E−02 | 1.0567E−02 |
| S10 | −6.0745E−02 | −2.3164E−02 | 5.2200E−02 | −4.3597E−02 | 2.3435E−02 | −8.8613E−03 | 2.3999E−03 |
| S11 | 5.7419E−03 | −2.9273E−02 | 2.9051E−02 | −2.1272E−02 | 1.0883E−02 | −3.9226E−03 | 1.0064E−03 |
| S12 | 4.3210E−02 | −6.6151E−03 | −1.1110E−02 | 8.0806E−03 | −2.9893E−03 | 7.2074E−04 | −1.2146E−04 |
| S13 | −1.1065E−01 | 4.8215E−02 | −2.0135E−02 | 6.6415E−03 | −1.5238E−03 | 2.4436E−04 | −2.8083E−05 |
| S14 | −1.2096E−01 | 5.3844E−02 | −2.0382E−02 | 5.7494E−03 | −1.1781E−03 | 1.7654E−04 | −1.9517E−05 |
| Surface number | A18 | A20 | A22 | A24 | A26 | A28 | A30 |
| S1 | 2.2060E−02 | −7.9702E−03 | 2.0993E−03 | −3.9267E−04 | 4.9444E−05 | −3.7563E−06 | 1.2993E−07 |
| S2 | 2.8581E−01 | −1.2600E−01 | 3.9411E−02 | −8.5437E−03 | 1.2205E−03 | −1.0334E−04 | 3.9281E−06 |
| S3 | 3.7350E−01 | −1.7862E−01 | 6.0469E−02 | −1.4156E−02 | 2.1793E−03 | −1.9847E−04 | 8.1008E−06 |
| S4 | −1.3031E+00 | 7.6161E−01 | −3.1438E−01 | 8.9507E−02 | −1.6713E−02 | 1.8412E−03 | −9.0661E−05 |
| S5 | 2.5881E+00 | −1.4069E+00 | 5.4697E−01 | −1.4817E−01 | 2.6549E−02 | −2.8262E−03 | 1.3530E−04 |
| S6 | 4.6516E−02 | −1.7306E−02 | 4.3729E−03 | −7.1635E−04 | 6.8579E−05 | −2.9110E−06 | 0.0000E+00 |
| S7 | −1.8097E−02 | 4.6436E−03 | −7.7503E−04 | 7.5728E−05 | −3.2865E−06 | 0.0000E+00 | 0.0000E+00 |
| S8 | −2.4136E−03 | 1.2603E−03 | −4.4215E−04 | 1.0218E−04 | −1.4959E−05 | 1.2596E−06 | −4.6529E−08 |
| S9 | −3.5058E−03 | 8.6339E−04 | −1.5548E−04 | 1.9853E−05 | −1.6995E−06 | 8.7356E−08 | −2.0367E−09 |
| S10 | −4.6499E−04 | 6.4024E−05 | −6.1807E−06 | 4.0726E−07 | −1.7386E−08 | 4.3179E−10 | −4.7174E−12 |
| S11 | −1.8506E−04 | 2.4387E−05 | −2.2795E−06 | 1.4734E−07 | −6.2573E−09 | 1.5699E−10 | −1.7630E−12 |
| S12 | 1.4706E−05 | −1.2896E−06 | 8.1349E−08 | −3.6049E−09 | 1.0671E−10 | −1.8975E−12 | 1.5350E−14 |
| S13 | 2.3522E−06 | −1.4426E−07 | 6.4237E−09 | −2.0248E−10 | 4.2885E−12 | −5.4804E−14 | 3.1961E−16 |
| S14 | 1.5971E−06 | −9.6293E−08 | 4.2157E−09 | −1.3013E−10 | 2.6813E−12 | −3.3060E−14 | 1.8430E−16 |

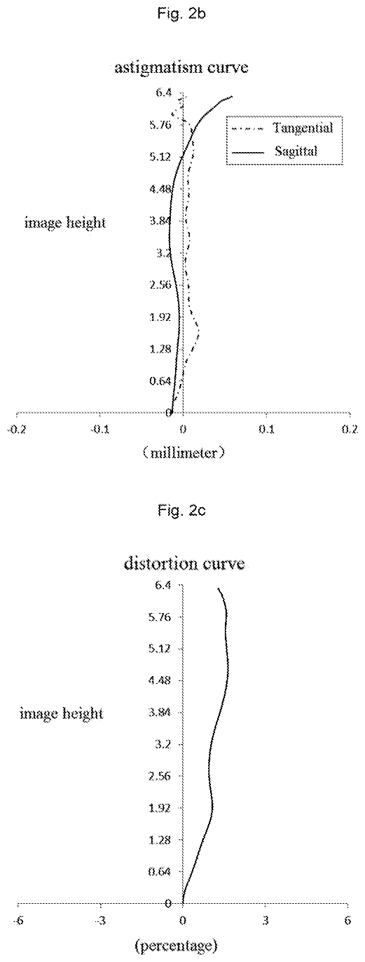

FIG. 2a shows a longitudinal aberration curve of the optical imaging camera lens assembly in Embodiment 1, which is the deviation of focus points of light with different wavelengths after passing through the camera lens. FIG. 2b shows an astigmatism curve of the optical imaging camera lens assembly in Embodiment 1, which is the curvature of a meridional image surface and the curvature of a sagittal image surface. FIG. 2c shows a distortion curve of the optical imaging camera lens assembly in Embodiment 1, which is distortion size values corresponding to different image heights. FIG. 2d shows a lateral color curve of the optical imaging camera lens assembly in Embodiment 1, which is the deviation of different image heights on the imaging plane after the light passes through the camera lens. It can be seen according to FIG. 2a to FIG. 2d that, the optical imaging camera lens assembly provided in Embodiment 1 can realize good imaging quality.

### Specific Embodiment 2

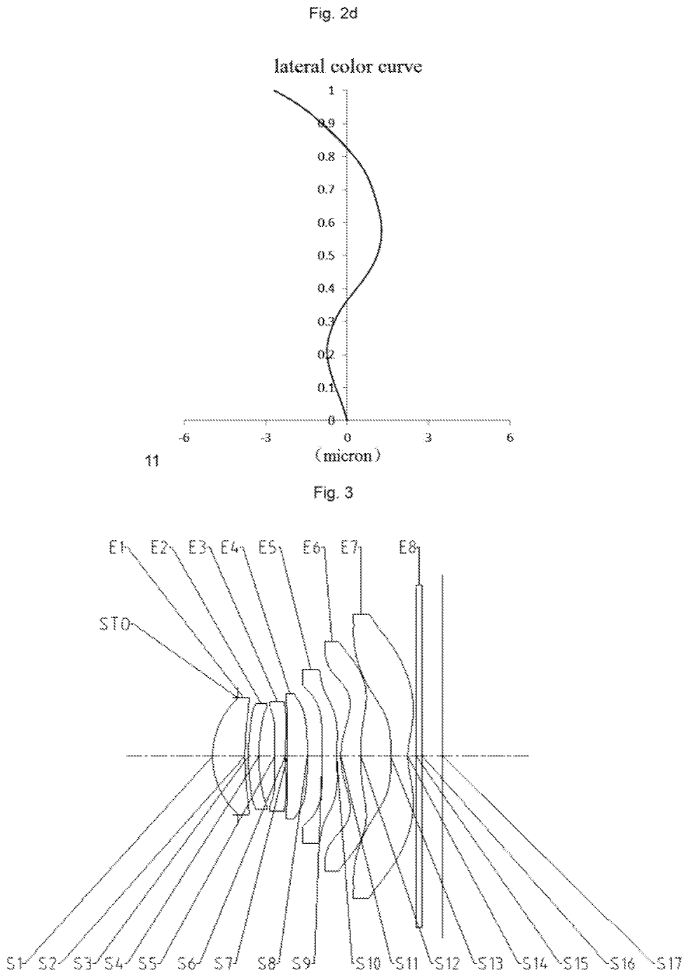

FIG. 3 is a schematic structural diagram of a lens group in Embodiment 2 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a concave surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 4, it is a basic parameter table of the optical imaging camera lens assembly in Embodiment 2, wherein the units of curvature radius, thickness and focal length are all millimeters (mm).

TABLE 4

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 2000.0000 | | | | |
| STO | Spherical | Infinite | −0.8789 | | | | |
| S1 | Aspheric | 2.7358 | 1.1200 | 7.91 | 1.50 | 81.6 | −0.0365 |
| S2 | Aspheric | 7.7342 | 0.1241 | | | | −30.3668 |
| S3 | Aspheric | 6.2865 | 0.3600 | −105.91 | 1.66 | 19.8 | 2.0464 |
| S4 | Aspheric | 5.6413 | 0.5501 | | | | −1.7826 |
| S5 | Aspheric | 20.4745 | 0.3700 | −25.79 | 1.67 | 19.0 | −45.7098 |
| S6 | Aspheric | 9.3604 | 0.0693 | | | | −1.0000 |
| S7 | Aspheric | 21.7129 | 0.6972 | 20.40 | 1.54 | 56.0 | −31.1512 |
| S8 | Aspheric | −22.5914 | 0.5200 | | | | 4.7295 |
| S9 | Aspheric | −530.5187 | 0.4999 | −12.99 | 1.57 | 37.3 | 80.0000 |
| S10 | Aspheric | 7.5142 | 0.1415 | | | | −5.0696 |
| 511 | Aspheric | 2.5659 | 0.6956 | 5.34 | 1.54 | 55.7 | −4.3251 |
| S12 | Aspheric | 22.0169 | 1.0319 | | | | 14.2657 |
| S13 | Aspheric | 19.0913 | 0.6000 | −4.90 | 1.54 | 55.7 | −25.4649 |
| S14 | Aspheric | 2.2899 | 0.2978 | | | | −1.1066 |
| S15 | Spherical | Infinite | 0.2100 | | 1.52 | 64.2 | |
| S16 | Spherical | Infinite | 0.7030 | | | | |
| S17 | Spherical | Infinite | | | | | |

As shown in Table 5, in Embodiment 2, a total effective focal length f of the optical imaging camera lens assembly is 6.52 mm, TTL is a distance on the optical axis from the object-side surface S1 of the first lens E1 to the imaging surface S17 of the optical imaging camera lens assembly, TTL is 7.99 mm, and ImgH is a half of a diagonal length of an effective pixel region on the imaging surface S17, ImgH is 6.33 mm.

TABLE 5
Embodiment 2

| | | | |
|---|---|---|---|
| f(mm) | 6.52 | TTL(mm) | 7.99 |
| ImgH(mm) | 6.33 | ImgH * ImgH/TTL(mm) | 5.01 |
| V1 | 81.61 | TTL/ImgH | 1.26 |
| f * tan(FOV/2)(mm) | 6.19 | (R1 + R2)/f1 | 1.32 |
| (f4 + f6)/(f4 − f6) | 1.71 | f3/(R6 − R5) | 2.32 |
| f5/f7 | 2.65 | (R11 + R12)/(R13 + R14) | 1.15 |
| f12/f56 | 0.92 | (SAG51 + SAG52)/ | 0.98 |
| | | (SAG61 + SAG62) | |
| (SAG71 + SAG72)/T67 | −2.55 | (CT3 + ET3)/(CT4 + ET4) | 0.88 |
| (ET5 + ET6)/ET7 | 1.96 | | |

The optical imaging camera lens assembly in Embodiment 2 satisfies:

ImgH*ImgH/TTL=5.01, wherein ImgH is the half of the diagonal length of the effective pixel region on the imaging surface, and TTL is an on-axis distance from the object-side surface of the first lens to the imaging surface.

V1=81.61, wherein V1 is an Abbe number of the first lens.

TTL/ImgH=1.26, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.32, wherein R1 is a curvature radius of the object-side surface of the first lens, R2 is the curvature radius of the image-side surface of the first lens, and f1 is the effective focal length of the first lens.

(f4+f6)/(f4−f6)=1.71, wherein f4 is the effective focal length of the fourth lens, and f6 is the effective focal length of the sixth lens.

f3/(R6−R5)=2.32, wherein R6 is the curvature radius of the image-side surface of the third lens, R5 is the curvature radius of the object-side surface of the third lens, and f3 is the effective focal length of the third lens.

f5/f7=2.65, wherein f5 is the effective focal length of the fifth lens, and f7 is the effective focal length of the seventh lens.

(R11+R12)/(R13+R14)=1.15, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=0.92, wherein f12 is a combined focal length of the first lens and the second lens, and f56 is the combined focal length of the fifth lens and the sixth lens.

(SAG51+SAG52)/(SAG61+SAG62)=0.98, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.55, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.88, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.96, wherein ET5 is the edge thickness of the fifth lens, ET6 is the edge thickness of the sixth lens, and ET7 is the edge thickness of the seventh lens.

In Embodiment 2, the object-side surface and the image-side surface of any one of the first lens E1 to the seventh lens E7 are both aspheric surfaces, and Table 6 shows high-order coefficients A4, A6, A8, A10, A12, A14, A16, A18, A20, A22, A24, A26, A28 and A30 that can be applied to various aspheric lens surfaces S1-S14 in Embodiment 2.

TABLE 6

| Surface number | A4 | A6 | A8 | A10 | A12 | A14 | A16 |
|---|---|---|---|---|---|---|---|
| S1 | −1.6470E−03 | 8.4757E−03 | −2.3966E−02 | 4.4599E−02 | −5.6678E−02 | 5.0986E−02 | −3.3266E−02 |
| S2 | −7.7707E−03 | 1.2261E−03 | 1.3566E−03 | 1.7462E−02 | −6.3252E−02 | 1.0733E−01 | −1.1223E−01 |
| S3 | −2.3260E−02 | 1.6487E−02 | −4.7085E−02 | 1.3869E−01 | −2.6322E−01 | 3.3602E−01 | −2.9912E−01 |
| S4 | −8.3909E−03 | −2.3220E−03 | 4.3208E−02 | −1.6850E−01 | 4.1970E−01 | −7.0250E−01 | 8.1485E−01 |
| S5 | −2.7579E−02 | 4.6168E−02 | −2.3788E−01 | 7.5219E−01 | −1.5856E+00 | 2.3193E+00 | −2.4151E+00 |
| S6 | −1.8129E−02 | −8.3316E−03 | 1.6002E−02 | −1.2860E−02 | −5.7472E−03 | 2.4318E−02 | −2.7244E−02 |
| S7 | −4.0007E−03 | −2.6310E−02 | 6.7040E−02 | −1.1100E−01 | 1.2318E−01 | −9.4188E−02 | 5.0396E−02 |
| S8 | −8.8108E−03 | −1.0587E−02 | 2.3680E−02 | −4.1289E−02 | 5.2595E−02 | −4.9866E−02 | 3.5024E−02 |
| S9 | −1.3235E−02 | −4.1392E−03 | 4.5276E−03 | 4.8088E−03 | −1.3521E−02 | 1.3273E−02 | −7.8108E−03 |
| S10 | −6.3315E−02 | −9.8804E−03 | 2.9095E−02 | −2.0293E−02 | 7.8573E−03 | −1.5802E−03 | −3.2836E−05 |
| S11 | 7.0842E−04 | −1.9074E−02 | 1.8032E−02 | −1.3372E−02 | 6.9377E−03 | −2.5172E−03 | 6.4676E−04 |
| S12 | 3.8498E−02 | −1.9904E−03 | −1.2989E−02 | 8.3917E−03 | −2.9452E−03 | 6.8618E−04 | −1.1295E−04 |
| S13 | −1.0669E−01 | 4.3912E−02 | −1.6403E−02 | 4.8489E−03 | −1.0H6E−03 | 1.4932E−04 | −1.5973E−05 |
| S14 | −1.1925E−01 | 5.2741E−02 | −1.9768E−02 | 5.5385E−03 | −1.1294E−03 | 1.6829E−04 | −1.8462E−05 |
| Surface number | A18 | A20 | A22 | A24 | A26 | A28 | A30 |
| S1 | 1.5961E−02 | −5.6499E−03 | 1.4617E−03 | −2.6918E−04 | 3.3429E−05 | −2.5075E−06 | 8.5678E−08 |
| S2 | 7.8541E−02 | −3.7969E−02 | 1.2749E−02 | −2.9234E−03 | 4.3706E−04 | −3.8413E−05 | 1.5059E−06 |
| S3 | 1.8916E−01 | −8.5429E−02 | 2.7338E−02 | −6.0496E−03 | 8.7961E−04 | −7.5547E−05 | 2.9019E−06 |
| S4 | −6.67HE−01 | 3.8779E−01 | −1.5894E−01 | 4.4855E−02 | −8.2874E−03 | 9.0169E−04 | −4.3765E−05 |
| S5 | 1.8133E+00 | −9.8317E−01 | 3.8106E−01 | −1.0286E−01 | 1.8355E−02 | −1.9454E−03 | 9.2700E−05 |
| S6 | 1.7637E−02 | −7.3758E−03 | 2.0250E−03 | −3.5299E−04 | 3.5447E−05 | −1.5615E−06 | 0.0000E+00 |
| S7 | −1.8820E−02 | 4.7944E−03 | −7.9213E−04 | 7.6387E−05 | −3.2611E−06 | 0.0000E+00 | 0.0000E+00 |
| S8 | −1.8064E−02 | 6.7740E−03 | −1.8185E−03 | 3.3970E−04 | −4.1872E−05 | 3.0584E−06 | −1.0017E−07 |
| S9 | 3.0787E−03 | −8.4105E−04 | 1.5979E−04 | −2.0694E−05 | 1.7373E−06 | −8.4818E−08 | 1.8155E−09 |
| S10 | 1.2094E−04 | −3.7640E−05 | 6.3873E−06 | −6.7131E−07 | 4.3631E−08 | −1.6133E−09 | 2.6033E−11 |
| S11 | −1.1883E−04 | 1.5639E−05 | −1.4605E−06 | 9.4359E−08 | −4.0068E−09 | 1.0054E−10 | −1.1293E−12 |
| S12 | 1.3471E−05 | −1.1717E−06 | 7.3712E−08 | −3.2706E−09 | 9.7153E−H | −1.7346E−12 | 1.4074E−14 |
| S13 | 1.2597E−06 | −7.3606E−08 | 3.1591E−09 | −9.7027E−11 | 2.0220E−12 | −2.5637E−14 | 1.4936E−16 |
| S14 | 1.4956E−06 | −8.9091E−08 | 3.8473E−09 | −1.1700E−10 | 2.3732E−12 | −2.8789E−14 | 1.5787E−16 |

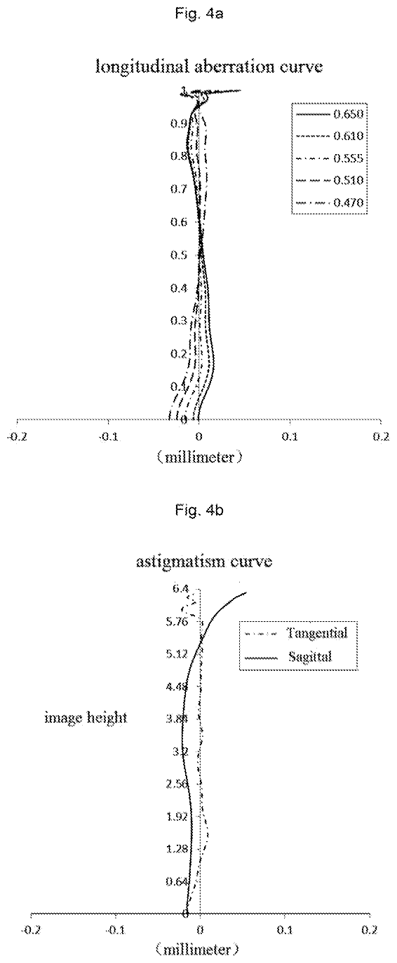

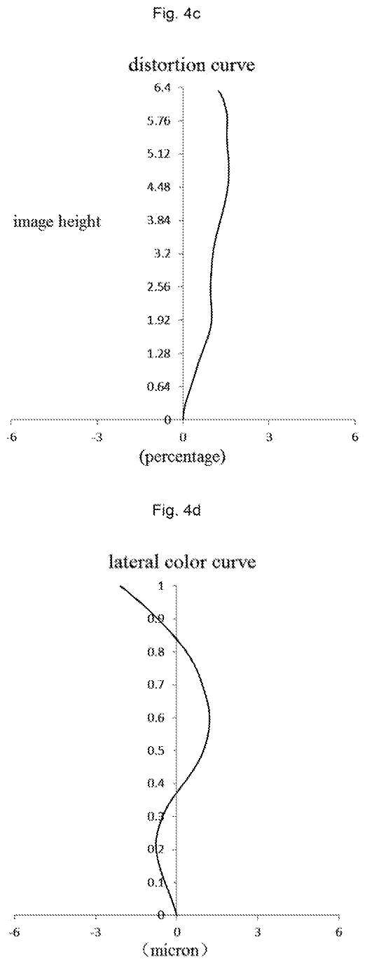

FIG. 4a shows a longitudinal aberration curve of the optical imaging camera lens assembly in Embodiment 2, which is the deviation of focus points of light with different wavelengths after passing through the camera lens. FIG. 4b shows an astigmatism curve of the optical imaging camera lens assembly in Embodiment 2, which is the curvature of a meridional image surface and the curvature of a sagittal image surface. FIG. 4c shows a distortion curve of the optical imaging camera lens assembly in Embodiment 2, which is distortion size values corresponding to different image heights. FIG. 4d shows a lateral color curve of the optical imaging camera lens assembly in Embodiment 2, which is the deviation of different image heights on the imaging plane after the light passes through the camera lens. It can be seen according to FIG. 4a to FIG. 4d that, the optical imaging camera lens assembly provided in Embodiment 2 can realize good imaging quality.

### Specific Embodiment 3

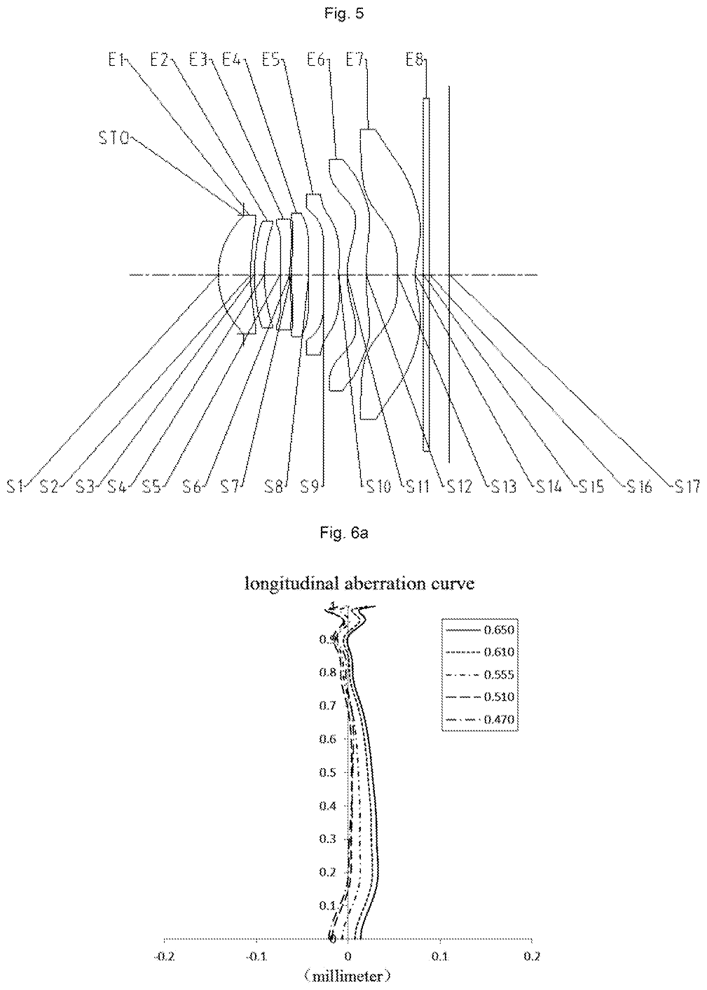

FIG. 5 is a schematic structural diagram of a lens group in Embodiment 3 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 7, it is a basic parameter table of the optical imaging camera lens assembly in Embodiment 3, wherein the units of curvature radius, thickness and focal length are all millimeters (mm).

TABLE 7

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 3000.0000 | | | | |
| STO | Spherical | Infinite | −0.8485 | | | | |
| S1 | Aspheric | 2.7201 | 1.0950 | 8.20 | 1.50 | 81.7 | −0.0511 |
| S2 | Aspheric | 7.0845 | 0.1245 | | | | −17.6726 |
| S3 | Aspheric | 5.6276 | 0.3400 | −164.31 | 1.67 | 19.2 | 3.0436 |
| S4 | Aspheric | 5.2258 | 0.5295 | | | | −1.8308 |
| S5 | Aspheric | 12.4820 | 0.3300 | −22.85 | 1.67 | 19.2 | 2.6370 |
| S6 | Aspheric | 6.8312 | 0.0559 | | | | −99.0000 |
| S7 | Aspheric | 9.5605 | 0.5805 | 21.25 | 1.54 | 56.1 | −43.2458 |
| S8 | Aspheric | 53.3959 | 0.5150 | | | | 80.0000 |
| S9 | Aspheric | 33.7386 | 0.5063 | −21.77 | 1.57 | 37.3 | −79.1031 |
| S10 | Aspheric | 9.0172 | 0.2759 | | | | −4.5662 |
| 511 | Aspheric | 2.6670 | 0.6477 | 6.08 | 1.54 | 56.1 | −4.4776 |
| S12 | Aspheric | 12.4387 | 1.0349 | | | | −0.3864 |
| S13 | Aspheric | 33.4767 | 0.6049 | −4.92 | 1.54 | 55.7 | 38.8990 |
| S14 | Aspheric | 2.4293 | 0.2721 | | | | −1.0547 |
| S15 | Spherical | Infinite | 0.2100 | | 1.52 | 64.2 | |
| S16 | Spherical | Infinite | 0.6746 | | | | |
| S17 | Spherical | Infinite | | | | | |

As shown in Table 8, in Embodiment 3, a total effective focal length f of the optical imaging camera lens assembly is 6.49 mm, TTL is a distance on the optical axis from the object-side surface S1 of the first lens E1 to the imaging surface S17 of the optical imaging camera lens assembly, TTL is 7.82 mm, and ImgH is a half of a diagonal length of an effective pixel region on the imaging surface S17, ImgH is 6.33 mm.

TABLE 8
Embodiment 3

| | | | |
|---|---|---|---|
| f(mm) | 6.49 | TTL(mm) | 7.82 |
| ImgH(mm) | 6.33 | ImgH*ImgH/TTL(mm) | 5.12 |
| V1 | 81.70 | TTL/ImgH | 1.24 |
| f*tan(FOV/2)(mm) | 6.18 | (RI + R2)/f1 | 1.20 |
| (f4 + f6)/(f4 − f6) | 1.80 | f3/(R6 − R5) | 4.04 |
| f5/f7 | 4.43 | (R11 + R12)/(R13 + R14) | 0.42 |
| f12/f56 | 0.99 | (SAG51 + SAG52)/(SAG61 + | 0.90 |
| | | SAG62) | |
| (SAG71 + SAG72)/T67 | −2.45 | (CT3 + ET3)/(CT4 + ET4) | 0.88 |
| (ET5 + ET6)/ET7 | 1.77 | | |

The optical imaging camera lens assembly in Embodiment 3 satisfies:

ImgH*ImgH/TTL=5.12, wherein ImgH is the half of the diagonal length of the effective pixel region on the imaging surface, and TTL is an on-axis distance from the object-side surface of the first lens to the imaging surface.

V1=81.70, wherein V1 is an Abbe number of the first lens.

TTL/ImgH=1.24, wherein TTL is the on-axis distance from the object-side surface of the first lens to the imaging surface, and ImgH is the half of the diagonal length of the effective pixel region on the imaging surface.

f*tan (FOV/2)=6.18, wherein f is an effective focal length of the optical imaging camera lens assembly, and FOV is a maximum field of view of the optical imaging camera lens assembly.

(R1+R2)/f1=1.20, wherein R1 is a curvature radius of the object-side surface of the first lens, R2 is the curvature radius of the image-side surface of the first lens, and f1 is the effective focal length of the first lens.

(f4+f6)/(f4−f6)=1.80, wherein f4 is the effective focal length of the fourth lens, and f6 is the effective focal length of the sixth lens.

f3/(R6−R5)=4.04, wherein R6 is the curvature radius of the image-side surface of the third lens, R5 is the curvature radius of the object-side surface of the third lens, and f3 is the effective focal length of the third lens.

f5/f7=4.43, wherein f5 is the effective focal length of the fifth lens, and f7 is the effective focal length of the seventh lens.

(R11+R12)/(R13+R14)=0.42, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=0.99, wherein f12 is a combined focal length of the first lens and the second lens, and f56 is the combined focal length of the fifth lens and the sixth lens.

(SAG51+SAG52)/(SAG61+SAG62)=0.90, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.45, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.88, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.77, wherein ET5 is the edge thickness of the fifth lens, ET6 is the edge thickness of the sixth lens, and ET7 is the edge thickness of the seventh lens.

In Embodiment 3, the object-side surface and the image-side surface of any one of the first lens E1 to the seventh lens E7 are both aspheric surfaces, and Table 9 shows high-order coefficients A4, A6, A8, A10, A12, A14, A16, A18, A20, A22, A24, A26, A28 and A30 that can be applied to various aspheric lens surfaces S1-S14 in Embodiment 3.

TABLE 9

| Surface number | A4 | A6 | A8 | A10 | A12 | A14 | A16 |
|---|---|---|---|---|---|---|---|
| S1 | −1.2632E−03 | 3.1859E−03 | −4.5427E−03 | 4.2073E−03 | −2.4719E−03 | 9.0924E−04 | −2.0261E−04 |
| S2 | −4.8130E−03 | 1.1198E−04 | 4.0475E−03 | −5.1527E−03 | 3.5608E−03 | −1.4969E−03 | 3.7636E−04 |
| S3 | −1.7989E−02 | 1.5704E−02 | −6.4609E−02 | 2.0060E−01 | −3.9336E−01 | 5.1687E−01 | −4.7246E−01 |
| S4 | −6.2397E−03 | 9.6943E−03 | −2.6365E−02 | 4.0199E−02 | 1.0192E−02 | −1.5191E−01 | 2.9454E−01 |
| S5 | −3.3517E−02 | 8.9140E−02 | −3.5411E−01 | 9.2490E−01 | −1.6805E+00 | 2.1791E+00 | −2.0544E+00 |
| S6 | 4.0987E−03 | −5.2566E−02 | 2.6606E−01 | −8.0555E−01 | 1.5117E+00 | −1.8998E+00 | 1.6672E+00 |
| S7 | −1.5788E−02 | −7.1948E−02 | 4.1353E−01 | −1.1390E+00 | 1.9551E+00 | −2.2731E+00 | 1.8609E+00 |
| S8 | −1.3506E−02 | −9.9273E−04 | −3.9357E−03 | 3.8314E−02 | −9.5275E−02 | 1.2670E−01 | −1.0666E−01 |
| S9 | −2.3944E−02 | −2.7231E−03 | 1.0993E−02 | 1.7407E−02 | −6.3658E−02 | 8.2472E−02 | −6.3978E−02 |
| S10 | −8.1231E−02 | 1.5264E−02 | 2.7082E−02 | −4.0902E−02 | 3.2668E−02 | −1.8168E−02 | 7.4016E−03 |
| S11 | −2.0519E−02 | −4.5299E−03 | 1.5243E−02 | −1.4499E−02 | 7.9555E−03 | −2.8955E−03 | 7.2915E−04 |
| S12 | 1.5707E−02 | −1.4228E−02 | 1.0196E−02 | −6.7269E−03 | 3.1175E−03 | −9.9703E−04 | 2.2231E−04 |
| S13 | −1.1428E−01 | 4.0693E−02 | −9.9791E−03 | 9.1615E−04 | 2.9778E−04 | −1.2251E−04 | 2.1812E−05 |
| S14 | −1.1877E−01 | 4.6757E−02 | −1.4440E−02 | 3.3117E−03 | −5.6906E−04 | 7.4021E−05 | −7.2709E−06 |
| Surface number | A18 | A20 | A22 | A24 | A26 | A28 | A30 |
| S1 | 2.4915E−05 | −1.3036E−06 | 0.0000E+00 | 0.0000E+00 | 0.0000E+00 | 0.0000E+00 | 0.0000E+00 |
| S2 | −5.1784E−05 | 2.9831E−06 | 0.0000E+00 | 0.0000E+00 | 0.0000E+00 | 0.0000E+00 | 0.0000E+00 |
| S3 | 3.0648E−01 | −1.4197E−01 | 4.6623E−02 | −1.0596E−02 | 1.5838E−03 | −1.4001E−04 | 5.5428E−06 |
| S4 | −3.1712E−01 | 2.2010E−01 | −1.0242E−01 | 3.1853E−02 | −6.3636E−03 | 7.3929E−04 | −3.7991E−05 |
| S5 | 1.4208E+00 | −7.2005E−01 | 2.6415E−01 | −6.8221E−02 | 1.1756E−02 | −1.2128E−03 | 5.6631E−05 |
| S6 | −1.0432E+00 | 4.6834E−01 | −1.4973E−01 | 3.3271E−02 | −4.8830E−03 | 4.2548E−04 | −1.6666E−05 |
| S7 | −1.0924E+00 | 4.6191E−01 | −1.3946E−01 | 2.9323E−02 | −4.0782E−03 | 3.3716E−04 | −1.2545E−05 |
| S8 | 6.0717E−02 | −2.3997E−02 | 6.6019E−03 | −1.2407E−03 | 1.5182E−04 | −1.0891E−05 | 3.4704E−07 |
| S9 | 3.3272E−02 | −1.2039E−02 | 3.0467E−03 | −5.2934E−04 | 6.0148E−05 | −4.0223E−06 | 1.1991E−07 |
| S10 | −2.2220E−03 | 4.8662E−04 | −7.6149E−05 | 8.2361E−06 | −5.8213E−07 | 2.4118E−08 | −4.4328E−10 |
| S11 | −1.2955E−04 | 1.6370E−05 | −1.4632E−06 | 9.0441E−08 | −3.6775E−09 | 8.8482E−11 | −9.5415E−13 |
| S12 | −3.4856E−05 | 3.8569E−06 | −2.9939E−07 | 1.5954E−08 | −5.5609E−10 | 1.1422E−11 | −1.0486E−13 |
| S13 | −2.3968E−06 | 1.7700E−07 | −8.9959E−09 | 3.1183E−10 | −7.0637E−12 | 9.4461E−14 | −5.6630E−16 |
| S14 | 5.3355E−07 | −2.8814E−08 | 1.1218E−09 | −3.0491E−11 | 5.4737E−13 | −5.8170E−15 | 2.7650E−17 |

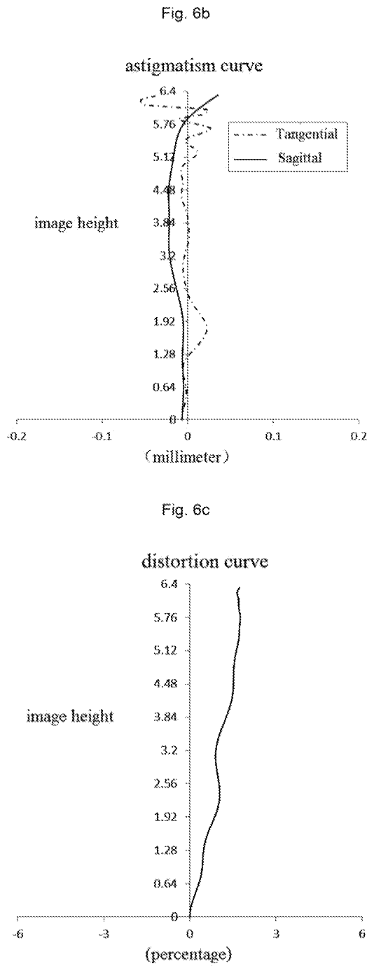

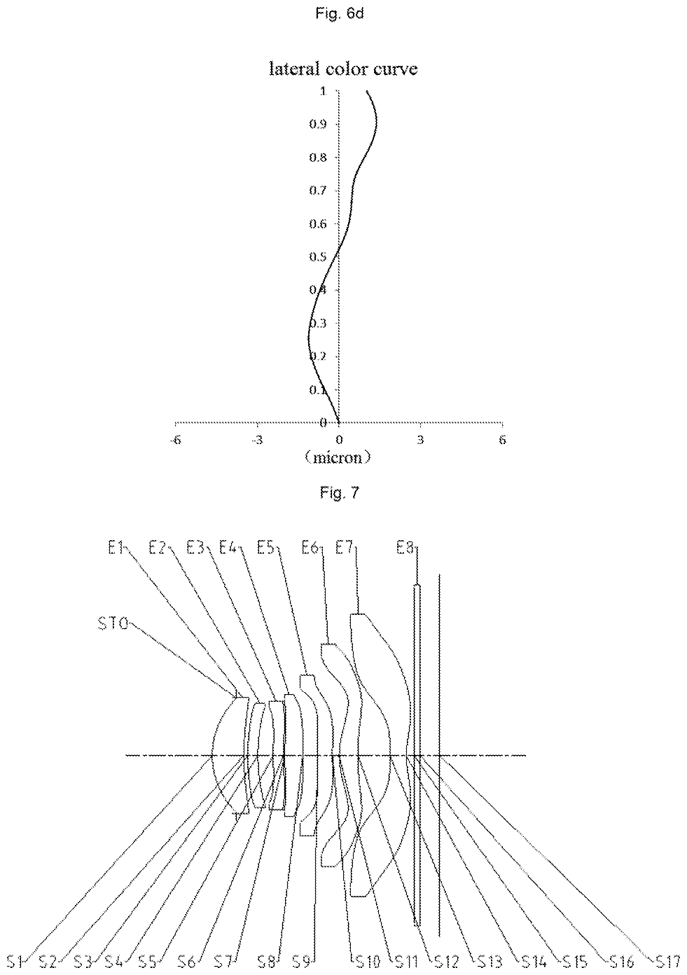

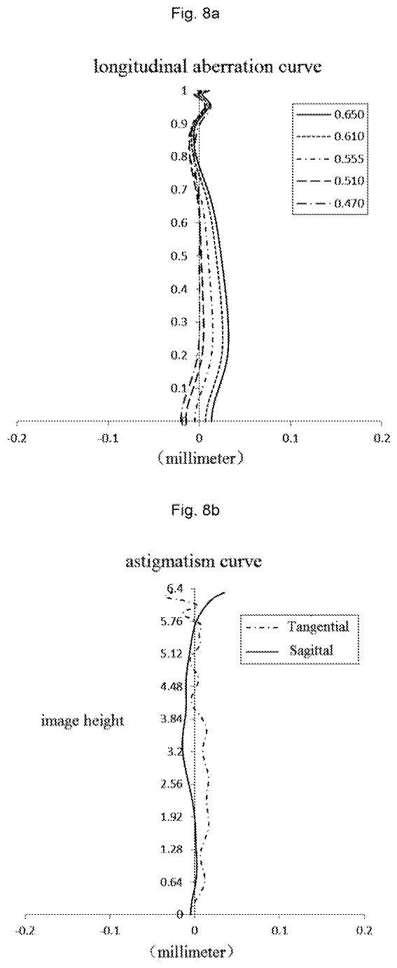

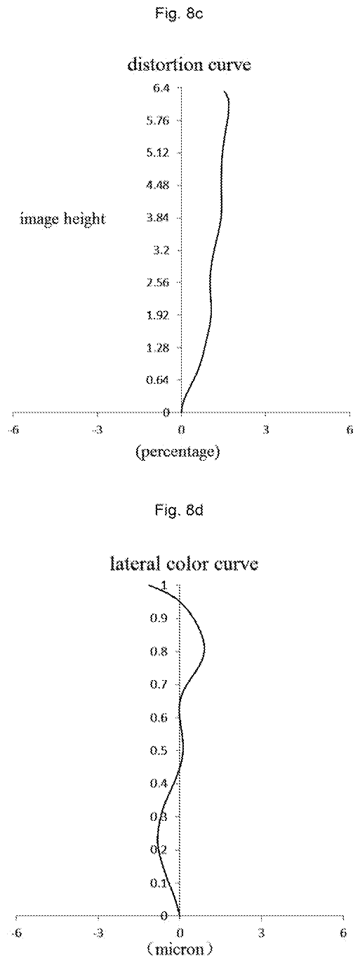

FIG. 6a shows a longitudinal aberration curve of the optical imaging camera lens assembly in Embodiment 3, which is the deviation of focus points of light with different wavelengths after passing through the camera lens. FIG. 6b shows an astigmatism curve of the optical imaging camera lens assembly in Embodiment 3, which is the curvature of a meridional image surface and the curvature of a sagittal image surface. FIG. 6c shows a distortion curve of the optical imaging camera lens assembly in Embodiment 3, which is distortion size values corresponding to different image heights. FIG. 6d shows a lateral color curve of the optical imaging camera lens assembly in Embodiment 3, which is the deviation of different image heights on the imaging plane after the light passes through the camera lens. It can be seen according to FIG. 6a to FIG. 6d that, the optical imaging camera lens assembly provided in Embodiment 3 can realize good imaging quality.

### Specific Embodiment 4

FIG. 7 is a schematic structural diagram of a lens group in Embodiment 4 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 10, it is a basic parameter table of the optical imaging camera lens assembly in Embodiment 4, wherein the units of curvature radius, thickness and focal length are all millimeters (mm).

TABLE 10

| | | | | | Material | | |
|---|---|---|---|---|---|---|---|
| Surface | Surface | Curvature | | Focal | Refractive | | Conic |
| number | type | radius | Thickness | length | index | Abbe number | coefficient |
| OBJ | Spherical | Infinite | 3000.0000 | | | | |
| STO | Spherical | Infinite | −0.8354 | | | | |
| S1 | Aspheric | 2.7590 | 1.0950 | 8.19 | 1.50 | 81.7 | −0.0447 |
| S2 | Aspheric | 7.4401 | 0.1393 | | | | −21.5921 |
| S3 | Aspheric | 6.0122 | 0.3500 | −230.46 | 1.62 | 25.9 | 2.7050 |
| S4 | Aspheric | 5.6405 | 0.5408 | | | | −2.5298 |
| S5 | Aspheric | 20.6329 | 0.3500 | −21.12 | 1.67 | 19.0 | 5.4972 |
| S6 | Aspheric | 8.3934 | 0.0513 | | | | −99.0000 |
| S7 | Aspheric | 12.5696 | 0.6234 | 21.69 | 1.54 | 56.0 | −52.2932 |
| S8 | Aspheric | −199.9818 | 0.5150 | | | | 80.0000 |
| S9 | Aspheric | 25.8487 | 0.5134 | −20.71 | 1.56 | 41.3 | −87.5401 |
| S10 | Aspheric | 8.0063 | 0.2378 | | | | −8.9217 |
| 511 | Aspheric | 2.6036 | 0.6542 | 5.90 | 1.54 | 56.1 | −4.6578 |
| S12 | Aspheric | 12.3932 | 1.1068 | | | | −0.6219 |
| S13 | Aspheric | 36.4931 | 0.5700 | −5.01 | 1.54 | 55.7 | 50.7457 |
| S14 | Aspheric | 2.4868 | 0.2758 | | | | −1.0401 |
| S15 | Spherical | Infinite | 0.2100 | | 1.52 | 64.2 | |
| S16 | Spherical | Infinite | 0.6782 | | | | |
| S17 | Spherical | Infinite | | | | | |

As shown in Table 11, in Embodiment 4, a total effective focal length f of the optical imaging camera lens assembly is 6.49 mm, TTL is a distance on the optical axis from the object-side surface S1 of the first lens E1 to the imaging surface S17 of the optical imaging camera lens assembly, TTL is 7.91 mm, and ImgH is a half of a diagonal length of an effective pixel region on the imaging surface S17, ImgH is 6.33 mm.

TABLE 11
Embodiment 4

| | | | |
|---|---|---|---|
| f(mm) | 6.49 | TTL(mm) | 7.91 |
| ImgH(mm) | 6.33 | ImgH * ImgH/TTL(mm) | 5.06 |
| V1 | 81.70 | TTL/ImgH | 1.25 |
| f * tan(FOV/2)(mm) | 6.20 | (R1 + R2)/f1 | 1.25 |
| (f4 + f6)/(f4 − f6) | 1.75 | f3/(R6 − R5) | 1.73 |
| f5/f7 | 4.14 | (R11 + R12)/(R13 + R14) | 0.38 |
| f12/f56 | 1.00 | (SAG51 + SAG52)/ | 0.88 |
| | | (SAG61 + SAG62) | |
| (SAG71 + SAG72)/T67 | −2.50 | (CT3 + ET3)/(CT4 + ET4) | 0.91 |
| (ET5 + ET6)/ET7 | 1.76 | | |

The optical imaging camera lens assembly in Embodiment 4 satisfies:

ImgH*ImgH/TTL=5.06, wherein ImgH is the half of the diagonal length of the effective pixel region on the imaging surface, and TTL is an on-axis distance from the object-side surface of the first lens to the imaging surface.

V1=81.70, wherein V1 is an Abbe number of the first lens.

TTL/ImgH=1.25, wherein TTL is the on-axis distance from the object-side surface of the first lens to the imaging surface, and ImgH is the half of the diagonal length of the effective pixel region on the imaging surface.

f*tan (FOV/2)=6.20, wherein f is an effective focal length of the optical imaging camera lens assembly, and FOV is a maximum field of view of the optical imaging camera lens assembly.

(R1+R2)/f1=1.25, wherein R1 is a curvature radius of the object-side surface of the first lens, R2 is the curvature radius of the image-side surface of the first lens, and f1 is the effective focal length of the first lens.

(f4+f6)/(f4−f6)=1.75, wherein f4 is the effective focal length of the fourth lens, and f6 is the effective focal length of the sixth lens.

f3/(R6−R5)=1.73, wherein R6 is the curvature radius of the image-side surface of the third lens, R5 is the curvature radius of the object-side surface of the third lens, and f3 is the effective focal length of the third lens.

f5/f7=4.14, wherein f5 is the effective focal length of the fifth lens, and f7 is the effective focal length of the seventh lens.

(R11+R12)/(R13+R14)=0.38, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.00, wherein f12 is a combined focal length of the first lens and the second lens, and f56 is the combined focal length of the fifth lens and the sixth lens.

(SAG51+SAG52)/(SAG61+SAG62)=0.90, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.50, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.91, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.76, wherein ET5 is the edge thickness of the fifth lens, ET6 is the edge thickness of the sixth lens, and ET7 is the edge thickness of the seventh lens.

In Embodiment 4, the object-side surface and the image-side surface of any one of the first lens E1 to the seventh lens E7 are both aspheric surfaces, and Table 12 shows high-order coefficients A4, A6, A8, A10, A12, A14, A16, A18, A20, A22, A24, A26, A28 and A30 that can be applied to various aspheric lens surfaces S1-S14 in Embodiment 4.

TABLE 12

| Surface number | A4 | A6 | A8 | A10 | A12 | A14 | A16 |
|---|---|---|---|---|---|---|---|
| S1 | −1.2632E−03 | 3.1859E−03 | −4.5427E−03 | 4.2073E−03 | −2.4719E−03 | 9.0924E−04 | −2.0261E−04 |
| S2 | −4.8130E−03 | 1.1198E−04 | 4.0475E−03 | −5.1527E−03 | 3.5608E−03 | −1.4969E−03 | 3.7636E−04 |
| S3 | −1.7989E−02 | 1.5704E−02 | −6.4609E−02 | 2.0060E−01 | −3.9336E−01 | 5.1687E−01 | −4.7246E−01 |
| S4 | −6.2397E−03 | 9.6943E−03 | −2.6365E−02 | 4.0199E−02 | 1.0192E−02 | −1.5191E−01 | 2.9454E−01 |
| S5 | −3.3517E−02 | 8.9140E−02 | −3.5411E−01 | 9.2490E−01 | −1.6805E+00 | 2.1791E+00 | −2.0544E+00 |
| S6 | 4.0987E−03 | −5.2566E−02 | 2.6606E−01 | −8.0555E−01 | 1.5117E+00 | −1.8998E+00 | 1.6672E+00 |
| S7 | −1.5788E−02 | −7.1948E−02 | 4.1353E−01 | −1.1390E+00 | 1.9551E+00 | −2.2731E+00 | 1.8609E+00 |
| S8 | −1.3506E−02 | −9.9273E−04 | −3.9357E−03 | 3.8314E−02 | −9.5275E−02 | 1.2670E−01 | −1.0666E−01 |
| S9 | −2.3944E−02 | −2.7231E−03 | 1.0993E−02 | 1.7407E−02 | −6.3658E−02 | 8.2472E−02 | −6.3978E−02 |
| S10 | −8.1231E−02 | 1.5264E−02 | 2.7082E−02 | −4.0902E−02 | 3.2668E−02 | −1.8168E−02 | 7.4016E−03 |
| S11 | −2.0519E−02 | −4.5299E−03 | 1.5243E−02 | −1.4499E−02 | 7.9555E−03 | −2.8955E−03 | 7.2915E−04 |
| S12 | 1.5707E−02 | −1.4228E−02 | 1.0196E−02 | −6.7269E−03 | 3.1175E−03 | −9.9703E−04 | 2.2231E−04 |
| S13 | −1.1428E−01 | 4.0693E−02 | −9.9791E−03 | 9.1615E−04 | 2.9778E−04 | −1.2251E−04 | 2.1812E−05 |
| S14 | −1.1877E−01 | 4.6757E−02 | −1.4440E−02 | 3.3117E−03 | −5.6906E−04 | 7.4021E−05 | −7.2709E−06 |
| Surface number | A18 | A20 | A22 | A24 | A26 | A28 | A30 |
| S1 | 2.4915E−05 | −1.3036E−06 | 0.0000E+00 | 0.0000E+00 | 0.0000E+00 | 0.0000E+00 | 0.0000E+00 |
| S2 | −5.1784E−05 | 2.9831E−06 | 0.0000E+00 | 0.0000E+00 | 0.0000E+00 | 0.0000E+00 | 0.0000E+00 |
| S3 | 3.0648E−01 | −1.4197E−01 | 4.6623E−02 | −1.0596E−02 | 1.5838E−03 | −1.4001E−04 | 5.5428E−06 |
| S4 | −3.1712E−01 | 2.2010E−01 | −1.0242E−01 | 3.1853E−02 | −6.3636E−03 | 73929E−04 | −3.7991E−05 |
| S5 | 1.4208E+00 | −7.2005E−01 | 2.6415E−01 | −6.8221E−02 | 1.1756E−02 | −1.2128E−03 | 5.6631E−05 |
| S6 | −1.0432E+00 | 4.6834E−01 | −1.4973E−01 | 3.3271E−02 | −4.8830E−03 | 4.2548E−04 | −1.6666E−05 |
| S7 | −1.0924E+00 | 4.6191E−01 | −1.3946E−01 | 2.9323E−02 | −4.0782E−03 | 33716E−04 | −1.2545E−05 |
| S8 | 6.0717E−02 | −2.3997E−02 | 6.6019E−03 | −1.2407E−03 | 1.5182E−04 | −1.0891E−05 | 3.4704E−07 |
| S9 | 3.3272E−02 | −1.2039E−02 | 3.0467E−03 | −5.2934E−04 | 6.0148E−05 | −4.0223E−06 | 1.1991E−07 |
| S10 | −2.2220E−03 | 4.8662E−04 | −7.6149E−05 | 8.2361E−06 | −5.8213E−07 | 2.4118E−08 | −4.4328E−10 |
| S11 | −1.2955E−04 | 1.6370E−05 | −1.4632E−06 | 9.0441E−08 | −3.6775E−09 | 8.8482E−11 | −9.5415E−13 |
| S12 | −3.4856E−05 | 3.8569E−06 | −2.9939E−07 | 1.5954E−08 | −5.5609E−10 | 1.1422E−11 | −1.0486E−13 |
| S13 | −2.3968E−06 | 1.7700E−07 | −8.9959E−09 | 3.1183E−10 | −7.0637E−12 | 9.4461E−14 | −5.6630E−16 |
| S14 | 5.3355E−07 | −2.8814E−08 | 1.1218E−09 | −3.0491E−11 | 5.4737E−13 | −5.8170E−15 | 2.7650E−17 |

FIG. 8a shows a longitudinal aberration curve of the optical imaging camera lens assembly in Embodiment 4, which is the deviation of focus points of light with different wavelengths after passing through the camera lens. FIG. 8b shows an astigmatism curve of the optical imaging camera lens assembly in Embodiment 4, which is the curvature of a meridional image surface and the curvature of a sagittal image surface. FIG. 8c shows a distortion curve of the optical imaging camera lens assembly in Embodiment 4, which is distortion size values corresponding to different image heights. FIG. 8d shows a lateral color curve of the optical imaging camera lens assembly in Embodiment 4, which is the deviation of different image heights on the imaging plane after the light passes through the camera lens. It can be seen according to FIG. 8a to FIG. 8d that, the optical imaging camera lens assembly provided in Embodiment 4 can realize good imaging quality.

### Specific Embodiment 5

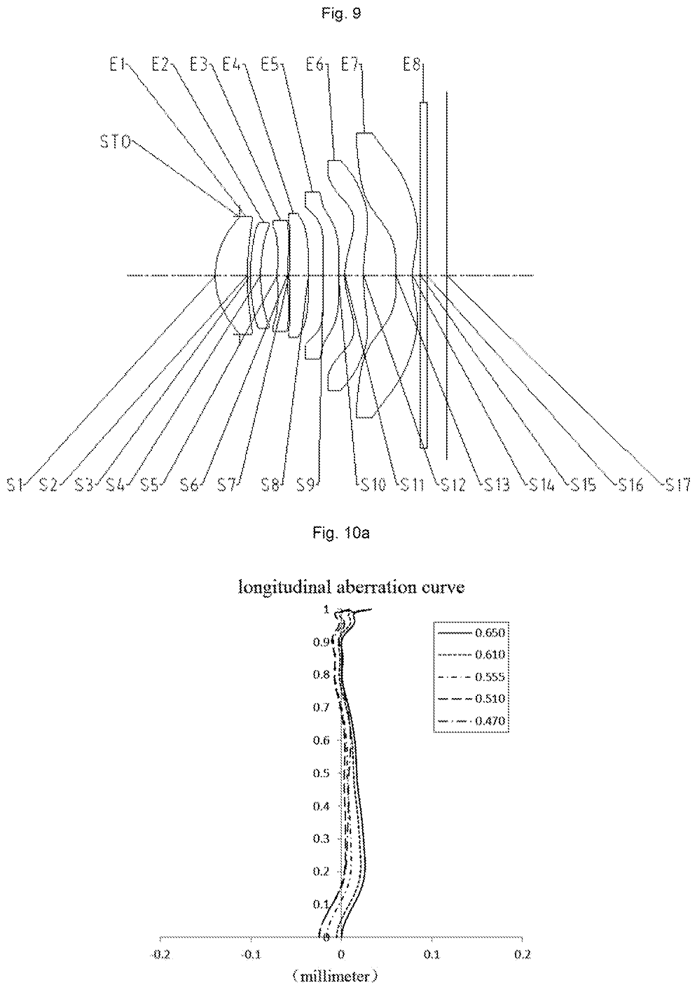

FIG. 9 is a schematic structural diagram of a lens group in Embodiment 5 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S1l thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 13, it is a basic parameter table of the optical imaging camera lens assembly in Embodiment 5, wherein the units of curvature radius, thickness and focal length are all millimeters (mm).

TABLE 13

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 3000.0000 | | | | |
| STO | Spherical | Infinite | −0.8325 | | | | |
| S1 | Aspheric | 2.7682 | 1.0950 | 8.14 | 1.49 | 83.7 | −0.0374 |
| S2 | Aspheric | 7.8334 | 0.1040 | | | | −19.8882 |
| S3 | Aspheric | 5.6486 | 0.3500 | −141.28 | 1.67 | 19.2 | 3.2933 |
| S4 | Aspheric | 5.2001 | 0.5781 | | | | −1.8495 |
| S5 | Aspheric | 17.4439 | 0.3500 | −20.19 | 1.67 | 19.2 | −13.1424 |
| S6 | Aspheric | 7.5972 | 0.0542 | | | | −1.0000 |
| S7 | Aspheric | 12.3777 | 0.6584 | 19.33 | 1.54 | 56.1 | −62.0082 |
| S8 | Aspheric | −69.8939 | 0.5150 | | | | −90.0000 |
| S9 | Aspheric | 43.3150 | 0.5138 | −19.44 | 1.57 | 37.3 | −81.1756 |
| S10 | Aspheric | 8.7773 | 0.2228 | | | | −5.3360 |
| 511 | Aspheric | 2.5153 | 0.6415 | 5.84 | 1.54 | 56.1 | −4.5899 |
| S12 | Aspheric | 10.8802 | 1.1076 | | | | −2.5894 |
| S13 | Aspheric | 33.1345 | 0.5700 | −4.96 | 1.54 | 55.7 | 38.5120 |
| S14 | Aspheric | 2.4476 | 0.2790 | | | | −1.0507 |
| S15 | Spherical | Infinite | 0.2100 | | 1.52 | 64.2 | |
| S16 | Spherical | Infinite | 0.6814 | | | | |
| S17 | Spherical | Infinite | | | | | |

As shown in Table 14, in Embodiment 5, a total effective focal length f of the optical imaging camera lens assembly is 6.48 mm, TTL is a distance on the optical axis from the object-side surface S1 of the first lens E1 to the imaging surface S17 of the optical imaging camera lens assembly, TTL is 7.93 mm, and ImgH is a half of a diagonal length of an effective pixel region on the imaging surface S17, ImgH is 6.33 mm.

TABLE 14
Embodiment 5

| | | | |
|---|---|---|---|
| f(mm) | 6.48 | TTL(mm) | 7.93 |
| ImgH(mm) | 6.33 | ImgH * ImgH/TTL(mm) | 5.05 |
| V1 | 83.70 | TTL/ImgH | 1.25 |
| f * tan(FOV/2)(mm) | 6.19 | (R1 + R2)/f1 | 1.30 |
| (f4 + f6)/(f4 − f6) | 1.87 | f3/(R6 − R5) | 2.05 |
| f5/f7 | 3.92 | (R11 + R12)/(R13 + R14) | 0.38 |
| f12/f56 | 1.00 | (SAG51 + SAG52)/ | 0.92 |
| | | (SAG61 + SAG62) | |
| (SAG71 + SAG72)/T67 | −2.48 | (CT3 + ET3)/(CT4 + ET4) | 0.87 |
| (ET5 + ET6)/ET7 | 1.83 | | |

The optical imaging camera lens assembly in Embodiment 5 satisfies:

ImgH*ImgH/TTL=5.05, wherein ImgH is the half of the diagonal length of the effective pixel region on the imaging surface, and TTL is an on-axis distance from the object-side surface of the first lens to the imaging surface.

V1=83.70, wherein V1 is an Abbe number of the first lens.

TTL/ImgH=1.25, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.30, wherein R1 is a curvature radius of the object-side surface of the first lens, R2 is the curvature radius of the image-side surface of the first lens, and f1 is the effective focal length of the first lens.

(f4+f6)/(f4−f6)=1.87, wherein f4 is the effective focal length of the fourth lens, and f6 is the effective focal length of the sixth lens.

f3/(R6−R5)=2.05, wherein R6 is the curvature radius of the image-side surface of the third lens, R5 is the curvature radius of the object-side surface of the third lens, and f3 is the effective focal length of the third lens.

f5/f7=3.92, wherein f5 is the effective focal length of the fifth lens, and f7 is the effective focal length of the seventh lens.

(R11+R12)/(R13+R14)=0.38, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.00, wherein f12 is a combined focal length of the first lens and the second lens, and f56 is the combined focal length of the fifth lens and the sixth lens.

(SAG51+SAG52)/(SAG61+SAG62)=0.92, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.48, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.87, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.83, wherein ET5 is the edge thickness of the fifth lens, ET6 is the edge thickness of the sixth lens, and ET7 is the edge thickness of the seventh lens.

In Embodiment 5, the object-side surface and the image-side surface of any one of the first lens E1 to the seventh lens E7 are both aspheric surfaces, and Table 15 shows high-order coefficients A4, A6, A8, A10, A12, A14, A16, A18, A20, A22, A24, A26, A28 and A30 that can be applied to various aspheric lens surfaces S1-S14 in Embodiment 5.

TABLE 15

| Surface number | A4 | A6 | A8 | A10 | A12 | A14 | A16 |
|---|---|---|---|---|---|---|---|
| S1 | −9.9357E−04 | 2.4547E−03 | −3.2970E−03 | 2.9057E−03 | −1.6509E−03 | 5.9917E−04 | −1.3402E−04 |
| S2 | −1.0160E−02 | 3.3495E−03 | 5.0772E−03 | −7.8323E−03 | 5.6616E−03 | −2.4385E−03 | 6.2618E−04 |
| S3 | −2.1573E−02 | 1.7313E−02 | −5.7590E−02 | 1.7944E−01 | −3.5291E−01 | 4.6192E−01 | −4.1922E−01 |
| S4 | −6.7680E−03 | 8.4373E−03 | −1.8683E−02 | 2.6759E−02 | 1.4572E−02 | −1.2126E−01 | 2.2164E−01 |
| S5 | −3.6540E−02 | 9.3487E−02 | −3.8603E−01 | 1.0548E+00 | −1.9869E+00 | 2.6450E+00 | −2.5383E+00 |
| S6 | −4.2124E−02 | 3.7717E−02 | −4.9081E−03 | −1.6416E−01 | 4.6001E−01 | −6.8931E−01 | 6.6646E−01 |
| S7 | −2.4771E−02 | 1.2806E−03 | 1.0305E−01 | −3.6326E−01 | 6.9557E−01 | −8.6165E−01 | 7.3147E−01 |
| S8 | −1.1624E−02 | −1.0374E−02 | 3.3331E−02 | −6.5489E−02 | 8.6195E−02 | −8.1136E−02 | 5.608 IE−02 |
| S9 | −2.2279E−02 | 2.9349E−02 | −7.1172E−02 | 1.2679E−01 | −1.5113E−01 | 1.2297E−01 | −7.0613E−02 |
| S10 | −7.9758E−02 | 3.4788E−02 | −2.3305E−02 | 23234E−02 | −1.8618E−02 | 1.0032E−02 | −3.6824E−03 |
| S11 | −1.2304E−02 | −4.0159E−03 | 4.2395E−03 | −3.4328E−03 | 1.8477E−03 | −6.6201E−04 | 1.5891E−04 |
| S12 | 2.6797E−02 | −1.6362E−02 | 3.8341E−03 | −1.1061E−03 | 6.1806E−04 | −2.6650E−04 | 7.1814E−05 |
| S13 | −1.0736E−01 | 3.7560E−02 | −1.1642E−02 | 2.6110E−03 | −3.0906E−04 | 3.0013E−06 | 4.7722E−06 |
| S14 | −1.1389E−01 | 4.5939E−02 | −1.5797E−02 | 4.1098E−03 | −7.8434E−04 | 1.1030E−04 | −1.1517E−05 |
| Surface number | A18 | A20 | A22 | A24 | A26 | A28 | A30 |
| S1 | 1.6770E−05 | −9.0382E−07 | 0.0000E+00 | 0.0000E+00 | 0.0000E+00 | 0.0000E+00 | 0.0000E+00 |
| S2 | −8.8070E−05 | 5.1999E−06 | 0.0000E+00 | 0.0000E+00 | 0.0000E+00 | 0.0000E+00 | 0.0000E+00 |
| S3 | 2.6957E−01 | −1.2366E−01 | 4.0190E−02 | −9.0348E−03 | 1.3354E−03 | −1.1670E−04 | 4.5666E−06 |
| S4 | −2.3044E−01 | 1.5555E−01 | −7.0648E−02 | 2.1492E−02 | −4.2062E−03 | 4.7920E−04 | −2.4165E−05 |
| S5 | 1.7747E+00 | −9.0436E−01 | 3.3217E−01 | −8.5609E−02 | 1.4684E−02 | −1.5047E−03 | 6.9680E−05 |
| S6 | −4.4090E−01 | 2.0399E−01 | −6.6071E−02 | 1.4697E−02 | −2.1409E−03 | 1.8400E−04 | −7.0756E−06 |
| S7 | −4.3645E−01 | 1.8467E−01 | −5.5124E−02 | 1.1352E−02 | −1.5351E−03 | 1.2272E−04 | −4.3957E−06 |
| S8 | −2.8662E−02 | 1.0780E−02 | −2.9360E−03 | 5.6162E−04 | −7.1364E−05 | 5.3973E−06 | −1.8353E−07 |
| S9 | 2.9155E−02 | −8.6982E−03 | 1.8588E−03 | −2.7732E−04 | 2.7403E−05 | −1.6097E−06 | 4.2494E−08 |
| S10 | 9.3868E−04 | −1.6710E−04 | 2.0615E−05 | −1.7207E−06 | 9.2344E−08 | −2.8619E−09 | 3.8675E−11 |
| S11 | −2.6136E−05 | 3.0064E−06 | −2.4348E−07 | 1.3688E−08 | −5.1071E−10 | 1.1400E−11 | −1.1533E−13 |
| S12 | −1.2581E−05 | 1.4863E−06 | −1.1995E−07 | 6.5414E−09 | −2.3100E−10 | 4.7758E−12 | −4.3936E−14 |
| S13 | −7.9492E−07 | 7.0459E−08 | −3.9799E−09 | 1.4796E−10 | −3.5246E−12 | 4.8971E−14 | −3.0261E−16 |
| S14 | 8.9444E−07 | −5.1370E−08 | 2.1485E−09 | −6.3526E−11 | 1.2573E−12 | −1.4934E−14 | 8.0466E−17 |

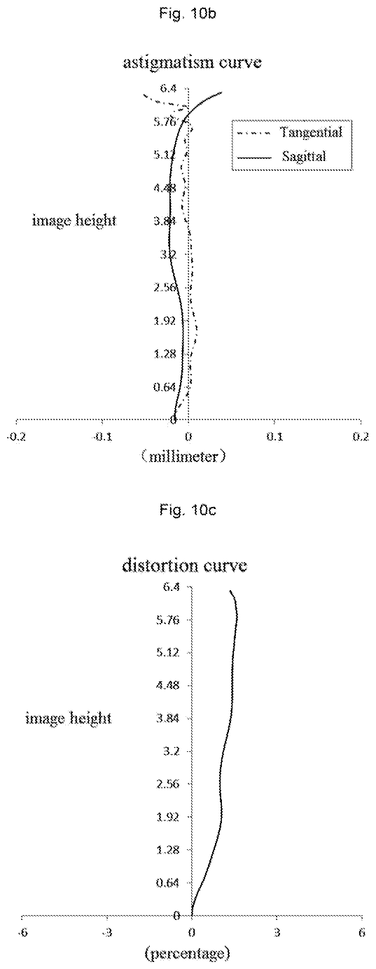

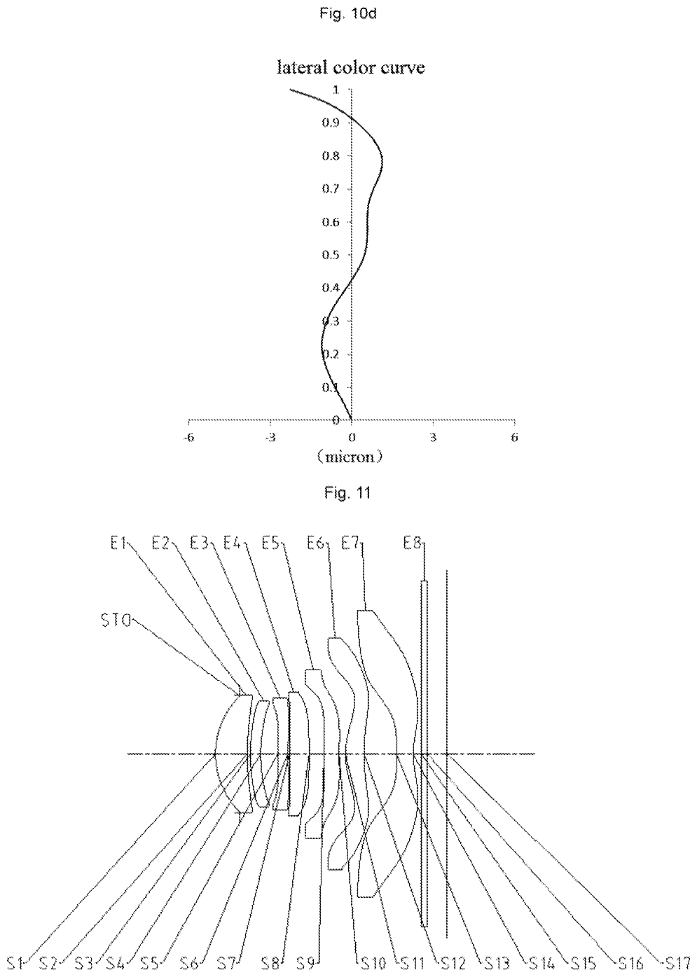

FIG. 10a shows a longitudinal aberration curve of the optical imaging camera lens assembly in Embodiment 5, which is the deviation of focus points of light with different wavelengths after passing through the camera lens. FIG. 10b shows an astigmatism curve of the optical imaging camera lens assembly in Embodiment 5, which is the curvature of a meridional image surface and the curvature of a sagittal image surface. FIG. 10c shows a distortion curve of the optical imaging camera lens assembly in Embodiment 5, which is distortion size values corresponding to different image heights. FIG. 10d shows a lateral color curve of the optical imaging camera lens assembly in Embodiment 5, which is the deviation of different image heights on the imaging plane after the light passes through the camera lens. It can be seen according to FIG. 10a to FIG. 10d that, the optical imaging camera lens assembly provided in Embodiment 5 can realize good imaging quality.

### Specific Embodiment 6

FIG. 11 is a schematic structural diagram of a lens group in Embodiment 6 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 16, it is a basic parameter table of the optical imaging camera lens assembly in Embodiment 6, wherein the units of curvature radius, thickness and focal length are all millimeters (mm).

TABLE 16

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 3000.0000 | | | | |
| STO | Spherical | Infinite | −0.8307 | | | | |
| S1 | Aspheric | 2.7755 | 1.0950 | 8.10 | 1.49 | 82.7 | −0.0339 |
| S2 | Aspheric | 7.9590 | 0.1057 | | | | −20.0691 |
| S3 | Aspheric | 5.7112 | 0.3500 | −124.81 | 1.67 | 19.2 | 3.3246 |
| S4 | Aspheric | 5.2170 | 0.5853 | | | | −1.8884 |
| S5 | Aspheric | 18.5390 | 0.3500 | −20.11 | 1.67 | 19.2 | −16.2458 |
| S6 | Aspheric | 7.7868 | 0.0530 | | | | −99.0000 |
| S7 | Aspheric | 12.5850 | 0.6694 | 19.35 | 1.54 | 56.1 | −64.5174 |
| S8 | Aspheric | −64.3112 | 0.5150 | | | | 80.0000 |
| S9 | Aspheric | 39.8392 | 0.5180 | −19.26 | 1.57 | 37.3 | −53.4447 |
| S10 | Aspheric | 8.5581 | 0.2188 | | | | −5.6726 |
| 511 | Aspheric | 2.4959 | 0.6399 | 5.79 | 1.54 | 56.1 | −4.5756 |
| S12 | Aspheric | 10.7885 | 1.1085 | | | | −2.2794 |
| S13 | Aspheric | 32.7381 | 0.5700 | −4.97 | 1.54 | 55.7 | 37.8571 |
| S14 | Aspheric | 2.4480 | 0.2796 | | | | −1.0506 |
| S15 | Spherical | Infinite | 0.2100 | | 1.52 | 64.2 | |
| S16 | Spherical | Infinite | 0.6820 | | | | |
| S17 | Spherical | Infinite | | | | | |

As shown in Table 17, in Embodiment 6, a total effective focal length f of the optical imaging camera lens assembly is 6.48 mm, TTL is a distance on the optical axis from the object-side surface S1 of the first lens E1 to the imaging surface S17 of the optical imaging camera lens assembly, TTL is 7.95 mm, and ImgH is a half of a diagonal length of an effective pixel region on the imaging surface S17. ImgH is 6.33 mm.

TABLE 17
Embodiment 6

| | | | |
|---|---|---|---|
| f(mm) | 6.48 | TTL(mm) | 7.95 |
| ImgH(mm) | 6.33 | ImgH * ImgH/TTL(mm) | 5.04 |
| V1 | 82.70 | TTL/ImgH | 1.26 |
| f * tan(FOV/2)(mm) | 6.19 | (R1 + R2)/f1 | 1.32 |
| (f4 + f6)/(f4 − f6) | 1.85 | f3/(R6 − R5) | 1.87 |
| f5/f7 | 3.88 | (R11 + R12)/(R13 + R14) | 0.38 |
| f12/f56 | 1.01 | (SAG51 + SAG52)/ | 0.92 |
| | | (SAG61 + SAG62) | |
| (SAG71 + SAG72)/T67 | −2.45 | (CT3 + ET3)/(CT4 + ET4) | 0.86 |
| (ET5 + ET6)/ET7 | 1.83 | | |

The optical imaging camera lens assembly in Embodiment 6 satisfies:

ImgH*ImgH/TTL=5.04, wherein ImgH is the half of the diagonal length of the effective pixel region on the imaging surface, and TTL is an on-axis distance from the object-side surface of the first lens to the imaging surface.

V1=82.70, wherein V1 is an Abbe number of the first lens.

TTL/ImgH=1.26, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.32, wherein R1 is a curvature radius of the object-side surface of the first lens, R2 is the curvature radius of the image-side surface of the first lens, and f1 is the effective focal length of the first lens.

(f4+f6)/(f4−f6)=1.85, wherein f4 is the effective focal length of the fourth lens, and f6 is the effective focal length of the sixth lens.

f3/(R6−R5)=1.87, wherein R6 is the curvature radius of the image-side surface of the third lens, R5 is the curvature radius of the object-side surface of the third lens, and f3 is the effective focal length of the third lens.

f5/f7=3.88, wherein f5 is the effective focal length of the fifth lens, and f7 is the effective focal length of the seventh lens.

(R11+R12)/(R13+R14)=0.38, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.01, wherein f12 is a combined focal length of the first lens and the second lens, and f56 is the combined focal length of the fifth lens and the sixth lens.

(SAG51+SAG52)/(SAG61+SAG62)=0.92, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.45, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.86, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.83, wherein ET5 is the edge thickness of the fifth lens, ET6 is the edge thickness of the sixth lens, and ET7 is the edge thickness of the seventh lens.

In Embodiment 6, the object-side surface and the image-side surface of any one of the first lens E1 to the seventh lens E7 are both aspheric surfaces, and Table 18 shows high-order coefficients A4, A6, A8, A10, A12, A14, A16, A18, A20, A22, A24, A26, A28 and A30 that can be applied to various aspheric lens surfaces S1-S14 in Embodiment 6.

TABLE 18

| Surface number | A4 | A6 | A8 | A10 | A12 | A14 | A16 |
|---|---|---|---|---|---|---|---|
| S1 | −9.9357E−04 | 2.4547E−03 | −3.2970E−03 | 2.9057E−03 | −1.6509E−03 | 5.9917E−04 | −1.3402E−04 |
| S2 | −1.0160E−02 | 3.3495E−03 | 5.0772E−03 | −7.8323E−03 | 5.6616E−03 | −2.4385E−03 | 6.2618E−04 |
| S3 | −2.1573E−02 | 1.7313E−02 | −5.7590E−02 | 1.7944E−01 | −3.5291E−01 | 4.6192E−01 | −4.1922E−01 |
| S4 | −6.7680E−03 | 8.4373E−03 | −1.8683E−02 | 2.6759E−02 | 1.4572E−02 | −1.2126E−01 | 2.2164E−01 |
| S5 | −3.6540E−02 | 9.3487E−02 | −3.8603E−01 | 1.0548E+00 | −1.9869E+00 | 2.6450E+00 | −2.5383E+00 |
| S6 | −4.2124E−02 | 3.7717E−02 | −4.9081E−03 | −1.6416E−01 | 4.6001E−01 | −6.8931E−01 | 6.6646E−01 |
| S7 | −2.4771E−02 | 1.2806E−03 | 1.0305E−01 | −3.6326E−01 | 6.9557E−01 | −8.6165E−01 | 7.3147E−01 |
| S8 | −1.1624E−02 | −1.0374E−02 | 3.3331E−02 | −6.5489E−02 | 8.6195E−02 | −8.1136E−02 | 5.6081E−02 |
| S9 | −2.2279E−02 | 2.9349E−02 | −7.1172E−02 | 1.2679E−01 | −1.5113E−01 | 1.2297E−01 | −7.0613E−02 |
| S10 | −7.9758E−02 | 3.4788E−02 | −2.3305E−02 | 2.3234E−02 | −1.8618E−02 | 1.0032E−02 | −3.6824E−03 |
| S11 | −1.2304E−02 | −4.0159E−03 | 4.2395E−03 | −3.4328E−03 | 1.8477E−03 | −6.6201E−04 | 1.5891E−04 |
| S12 | 2.6797E−02 | −1.6362E−02 | 3.8341E−03 | −1.1061E−03 | 6.1806E−04 | −2.6650E−04 | 7.1814E−05 |
| S13 | −1.0736E−01 | 3.7560E−02 | −1.1642E−02 | 2.6110E−03 | −3.0906E−04 | 3.0013E−06 | 4.7722E−06 |
| S14 | −1.1389E−01 | 4.5939E−02 | −1.5797E−02 | 4.1098E−03 | −7.8434E−04 | 1.1030E−04 | −1.1517E−05 |
| Surface number | A18 | A20 | A22 | A24 | A26 | A28 | A30 |
| S1 | 1.6770E−05 | −9.0382E−07 | 0.0000E+00 | 0.0000E+00 | 0.0000E+00 | 0.0000E+00 | 0.0000E+00 |
| S2 | −8.8070E−05 | 5.1999E−06 | 0.0000E+00 | 0.0000E+00 | 0.0000E+00 | 0.0000E+00 | 0.0000E+00 |
| S3 | 2.6957E−01 | −1.2366E−01 | 4.0190E−02 | −9.0348E−03 | 1.3354E−03 | −1.1670E−04 | 4.5666E−06 |
| S4 | −2.3044E−01 | 1.5555E−01 | −7.0648E−02 | 2.1492E−02 | −4.2062E−03 | 4.7920E−04 | −2.4165E−05 |
| S5 | 1.7747E+00 | −9.0436E−01 | 3.3217E−01 | −8.5609E−02 | 1.4684E−02 | −1.5047E−03 | 6.9680E−05 |
| S6 | −4.4090E−01 | 2.0399E−01 | −6.6071E−02 | 1.4697E−02 | −2.1409E−03 | 1.8400E−04 | −7.0756E−G6 |
| S7 | −4.3645E−01 | 1.8467E−01 | −5.5124E−02 | 1.1352E−02 | −1.5351E−03 | 1.2272E−04 | −4.3957E−06 |
| S8 | −2.8662E−02 | 1.0780E−02 | −2.9360E−03 | 5.6162E−04 | −7.1364E−05 | 5.3973E−06 | −1.8353E−07 |
| S9 | 2.9155E−02 | −8.6982E−03 | 1.8588E−03 | −2.7732E−04 | 2.7403E−05 | −1.6097E−06 | 4.2494E−08 |
| S10 | 9.3868E−04 | −1.6710E−04 | 2.0615E−05 | −1.7207E−06 | 9.2344E−08 | −2.8619E−09 | 3.8675E−11 |
| S11 | −2.6136E−05 | 3.0064E−06 | −2.4348E−07 | 1.3688E−08 | −5.1071E−10 | 1.1400E−11 | −1.1533E−13 |
| S12 | −1.2581E−05 | 1.4863E−06 | −1.1995E−07 | 6.5414E−09 | −2.3100E−10 | 4.7758E−12 | −4.3936E−14 |
| S13 | −7.9492E−07 | 7.0459E−08 | −3.9799E−09 | 1.4796E−10 | −3.5246E−12 | 4.8971E−14 | −3.0261E−16 |
| S14 | 8.9444E−07 | −5.1370E−08 | 2.1485E−09 | −6.3526E−11 | 1.2573E−12 | −1.4934E−14 | 8.0466E−17 |

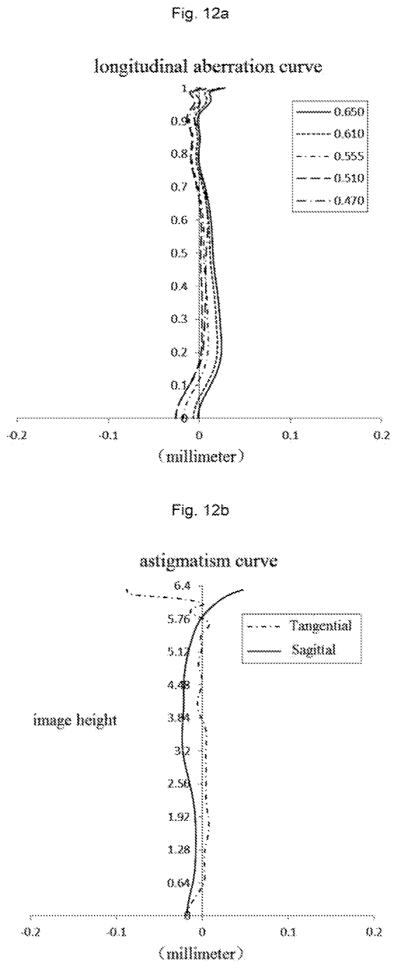

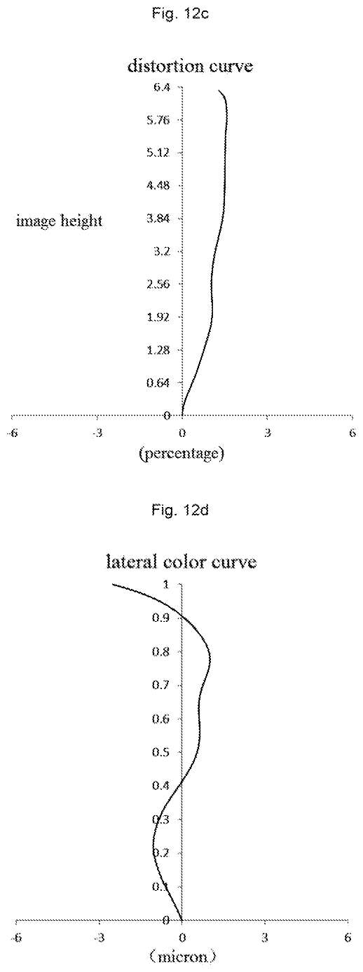

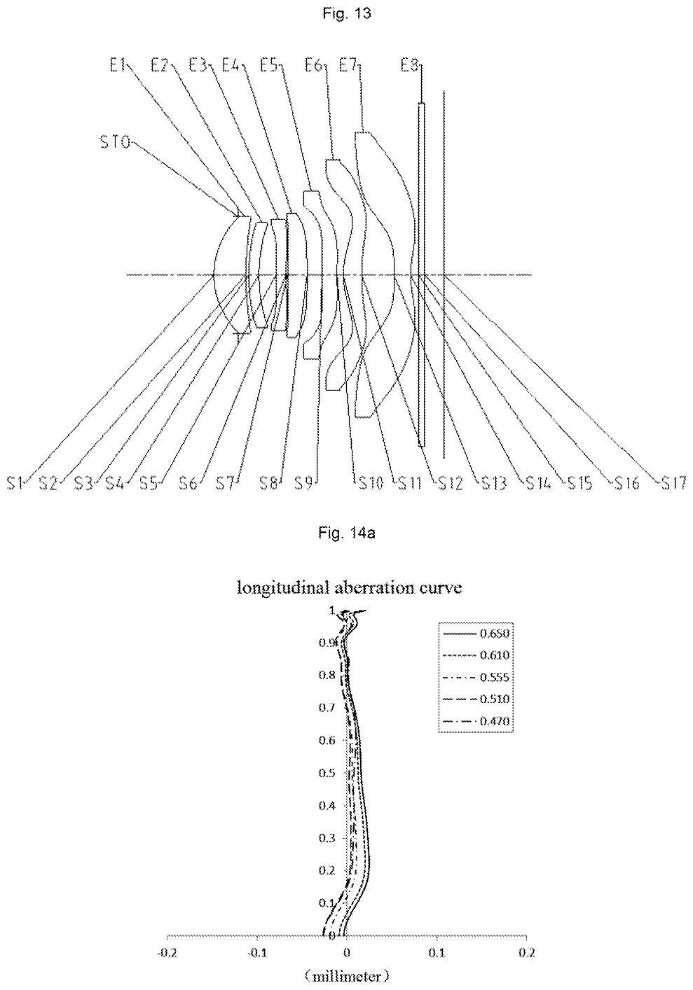

FIG. 12a shows a longitudinal aberration curve of the optical imaging camera lens assembly in Embodiment 6, which is the deviation of focus points of light with different wavelengths after passing through the camera lens. FIG. 12b shows an astigmatism curve of the optical imaging camera lens assembly in Embodiment 6, which is the curvature of a meridional image surface and the curvature of a sagittal image surface. FIG. 12c shows a distortion curve of the optical imaging camera lens assembly in Embodiment 6, which is distortion size values corresponding to different image heights. FIG. 12d shows a lateral color curve of the optical imaging camera lens assembly in Embodiment 6, which is the deviation of different image heights on the imaging plane after the light passes through the camera lens. It can be seen according to FIG. 12a to FIG. 12d that, the optical imaging camera lens assembly provided in Embodiment 6 can realize good imaging quality.

### Specific Embodiment 7

FIG. 13 is a schematic structural diagram of a lens group in Embodiment 7 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S1l thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 19, it is a basic parameter table of the optical imaging camera lens assembly in Embodiment 7, wherein the units of curvature radius, thickness and focal length are all millimeters (mm).

TABLE 19

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 3000.0000 | | | | |
| STO | Spherical | Infinite | −0.8307 | | | | |
| S1 | Aspheric | 2.7755 | 1.0950 | 8.10 | 1.49 | 84.0 | −0.0353 |
| S2 | Aspheric | 7.9590 | 0.1057 | | | | −20.2663 |
| S3 | Aspheric | 5.7112 | 0.3500 | −126.39 | 1.66 | 20.8 | 3.3077 |
| S4 | Aspheric | 5.2170 | 0.5853 | | | | −1.9589 |
| S5 | Aspheric | 18.5390 | 0.3500 | −19.70 | 1.67 | 19.2 | −14.7175 |
| S6 | Aspheric | 7.7868 | 0.0530 | | | | −1.0000 |
| S7 | Aspheric | 12.5850 | 0.6696 | 19.01 | 1.57 | 56.1 | −61.6114 |
| S8 | Aspheric | −64.3112 | 0.5150 | | | | 74.4861 |
| S9 | Aspheric | 39.8392 | 0.5180 | −19.02 | 1.57 | 37.3 | −43.9234 |
| S10 | Aspheric | 8.5581 | 0.2188 | | | | −5.8194 |
| 511 | Aspheric | 2.4959 | 0.6399 | 5.77 | 1.54 | 56.1 | −4.5829 |
| S12 | Aspheric | 10.7885 | 1.1085 | | | | −2.3327 |
| S13 | Aspheric | 32.7381 | 0.5700 | −4.96 | 1.54 | 55.7 | 37.4796 |
| S14 | Aspheric | 2.4480 | 0.2796 | | | | −1.0526 |
| S15 | Spherical | Infinite | 0.2100 | | 1.52 | 64.2 | |
| S16 | Spherical | Infinite | 0.6820 | | | | |
| S17 | Spherical | Infinite | | | | | |

As shown in Table 20, in Embodiment 7, a total effective focal length f of the optical imaging camera lens assembly is 6.48 mm, TTL is a distance on the optical axis from the object-side surface S1 of the first lens E1 to the imaging surface S17 of the optical imaging camera lens assembly, TTL is 7.95 mm, and ImgH is a half of a diagonal length of an effective pixel region on the imaging surface S17, ImgH is 6.33 mm.

TABLE 20
Embodiment 7

| | | | |
|---|---|---|---|
| f(mm) | 6.48 | TTL(mm) | 7.95 |
| ImgH(mm) | 6.33 | ImgH * ImgH/TTL(mm) | 5.04 |
| V1 | 84.00 | TTL/ImgH | 1.26 |
| f * tan(FOV/2)(mm) | 6.19 | (R1 + R2)/f1 | 1.33 |
| (f4 + f6)/(f4 − f6) | 1.87 | f3/(R6 − R5) | 1.81 |
| f5/f7 | 3.84 | (R11 + R12)/(R13 + R14) | 0.38 |
| f12/f56 | 1.01 | (SAG51 + SAG52)/ | 0.92 |
| | | (SAG61 + SAG62) | |
| (SAG71 + SAG72)/T67 | −2.45 | (CT3 + ET3)/(CT4 + ET4) | 0.86 |
| (ET5 + ET6)/ET7 | 1.84 | | |

The optical imaging camera lens assembly in Embodiment 7 satisfies:

ImgH*ImgH/TTL=5.04, wherein ImgH is the half of the diagonal length of the effective pixel region on the imaging surface, and TTL is an on-axis distance from the object-side surface of the first lens to the imaging surface.

V1=84.00, wherein V1 is an Abbe number of the first lens.

TTL/ImgH=1.26, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.33, wherein R1 is a curvature radius of the object-side surface of the first lens, R2 is the curvature radius of the image-side surface of the first lens, and f1 is the effective focal length of the first lens.

(f4+f6)/(f4−f6)=1.87, wherein f4 is the effective focal length of the fourth lens, and f6 is the effective focal length of the sixth lens.

f3/(R6−R5)=1.81, wherein R6 is the curvature radius of the image-side surface of the third lens, R5 is the curvature radius of the object-side surface of the third lens, and f3 is the effective focal length of the third lens.

f5/f7=3.84, wherein f5 is the effective focal length of the fifth lens, and f7 is the effective focal length of the seventh lens.

(R11+R12)/(R13+R14)=0.38, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.01, wherein f12 is a combined focal length of the first lens and the second lens, and f56 is the combined focal length of the fifth lens and the sixth lens.

(SAG51+SAG52)/(SAG61+SAG62)=0.92, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.45, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.86, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.84, wherein ET5 is the edge thickness of the fifth lens, ET6 is the edge thickness of the sixth lens, and ET7 is the edge thickness of the seventh lens.

In Embodiment 7, the object-side surface and the image-side surface of any one of the first lens E1 to the seventh lens E7 are both aspheric surfaces, and Table 21 shows high-order coefficients A4, A6, A8, A10, A12, A14, A16, A18, A20, A22, A24, A26, A28 and A30 that can be applied to various aspheric lens surfaces S1-S14 in Embodiment 7.

TABLE 21

| Surface number | A4 | A6 | A8 | A10 | A12 | A14 | A16 |
|---|---|---|---|---|---|---|---|
| S1 | −9.2682E−04 | 2.3868E−03 | −3.2379E−03 | 2.8454E−03 | −1.5982E−03 | 5.7114E−04 | −1.2572E−04 |
| S2 | −1.0604E−02 | 4.4521E−03 | 3.0235E−03 | −5.5267E−03 | 4.0717E−03 | −1.7558E−03 | 4.4884E−04 |
| S3 | −2.2156E−02 | 1.7751E−02 | −5.6700E−02 | 1.7486E−01 | −3.4426E−01 | 4.5315E−01 | −4.1459E−01 |
| S4 | −6.5805E−03 | 2.4481E−03 | 1.2301E−02 | −6.8190E−02 | 2.0638E−01 | −3.9018E−01 | 4.9126E−01 |
| S5 | −3.6057E−02 | 9.0897E−02 | −3.7873E−01 | 1.0373E+00 | −1.9512E+00 | 2.5882E+00 | −2.4716E+00 |
| S6 | −4.1772E−02 | 3.9974E−02 | −1.8821E−02 | −1.2584E−01 | 3.9245E−01 | −6.0542E−01 | 5.9108E−01 |
| S7 | −2.4020E−02 | 9.6751E−04 | 1.0027E−01 | −3.5254E−01 | 6.7123E−01 | −8.2435E−01 | 6.9259E−01 |
| S8 | −8.5794E−03 | −2.5668E−02 | 7.8991E−02 | −1.5392E−01 | 2.0205E−01 | −1.8734E−01 | 1.2568E−01 |
| S9 | −2.0724E−02 | 2.5636E−02 | −5.9793E−02 | 1.0386E−01 | −1.2102E−01 | 9.6114E−02 | −5.3812E−02 |
| S10 | −8.0859E−02 | 3.6355E−02 | −2.3798E−02 | 2.2294E−02 | −1.7188E−02 | 9.0513E−03 | −3.2691E−03 |
| S11 | −1.2728E−02 | −3.0214E−03 | 3.2295E−03 | −2.7409E−03 | 1.4736E−03 | −5.0951E−04 | 1.1505E−04 |
| S12 | 2.7795E−02 | −1.6889E−02 | 4.1780E−03 | −1.3428E−03 | 7.1777E−04 | −2.9038E−04 | 7.4926E−05 |
| S13 | −1.0665E−01 | 3.7775E−02 | −1.1866E−02 | 2.7028E−03 | −3.3776E−04 | 9.6432E−06 | 3.6992E−06 |
| S14 | −1.1440E−01 | 4.7149E−02 | −1.6611E−02 | 4.4244E−03 | −8.6413E−04 | 1.2433E−04 | −1.3276E−05 |
| Surface number | A18 | A20 | A22 | A24 | A26 | A28 | A30 |
| S1 | 1.5503E−05 | −8.2565E−07 | 0.0000E+00 | 0.0000E+00 | 0.0000E+00 | 0.0000E+00 | 0.0000E+00 |
| S2 | −6.2622E−05 | 3.6547E−06 | 0.0000E+00 | 0.0000E+00 | 0.0000E+00 | 0.0000E+00 | 0.0000E+00 |
| S3 | 2.6915E−01 | −1.2478E−01 | 4.1013E−02 | −9.3294E−03 | 1.3960E−03 | −1.2355E−04 | 4.8975E−06 |
| S4 | −4.2662E−01 | 2.5942E−01 | −1.1026E−01 | 3.2086E−02 | −6.0919E−03 | 6.7967E−04 | −3.3792E−05 |
| S5 | 1.7180E+00 | −8.6974E−01 | 3.1721E−01 | −8.1149E−02 | 1.3813E−02 | −1.4045E−03 | 6.4533E−05 |
| S6 | −3.9167E−01 | 1.8074E−01 | −5.8241E−02 | 1.2868E−02 | −1.8596E−03 | 1.5842E−04 | −6.0350E−06 |
| S7 | −4.0865E−01 | 1.7091E−01 | −5.0415E−02 | 1.0258E−02 | −1.3704E−03 | 1.0821E−04 | −3.8283E−06 |
| S8 | −6.169E−02 | 2.2051E−02 | −5.6910E−03 | 1.0300E−03 | −1.2390E−04 | 8.8851E−06 | −2.8719E−07 |
| S9 | 2.1658E−02 | −6.3013E−03 | 1.3144E−03 | −1.9163E−04 | 1.8528E−05 | −1.0662E−06 | 2.7603E−08 |
| S10 | 8.2282E−04 | −1.4493E−04 | 1.7720E−05 | −1.4686E−06 | 7.8457E−08 | −2.4296E−09 | 3.2994E−11 |
| S11 | −1.7440E−05 | 1.8201E−06 | −1.3253E−07 | 6.7044E−09 | −2.2786E−10 | 4.7404E−12 | −4.6037E−14 |
| S12 | −1.2725E−05 | 1.4674E−06 | −1.1612E−07 | 6.2280E−09 | −2.1683E−10 | 4.4282E−12 | −4.0308E−14 |
| S13 | −6.7496E−07 | 6.1125E−08 | −3.4751E−09 | 1.2930E−10 | −3.0748E−12 | 4.2578E−14 | −2.6190E−16 |
| S14 | 1.0542E−06 | −6.1898E−08 | 2.6462E−09 | −7.9951E−11 | 1.6161E−12 | −1.9591E−14 | 1.0763E−16 |

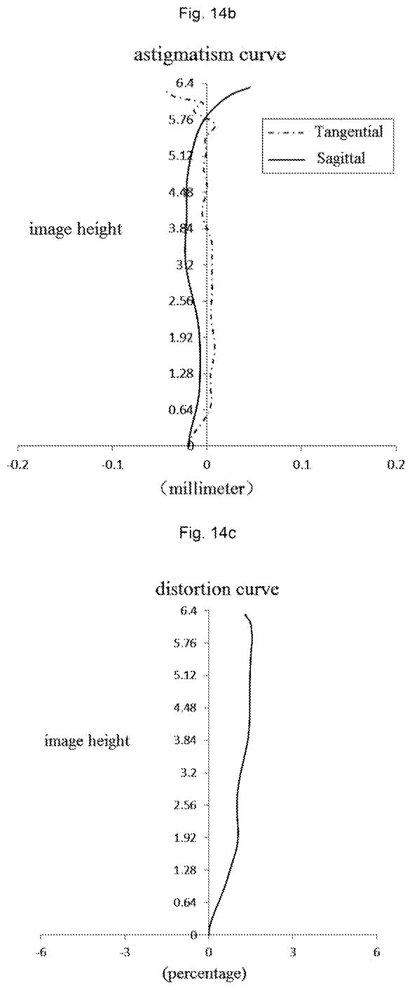

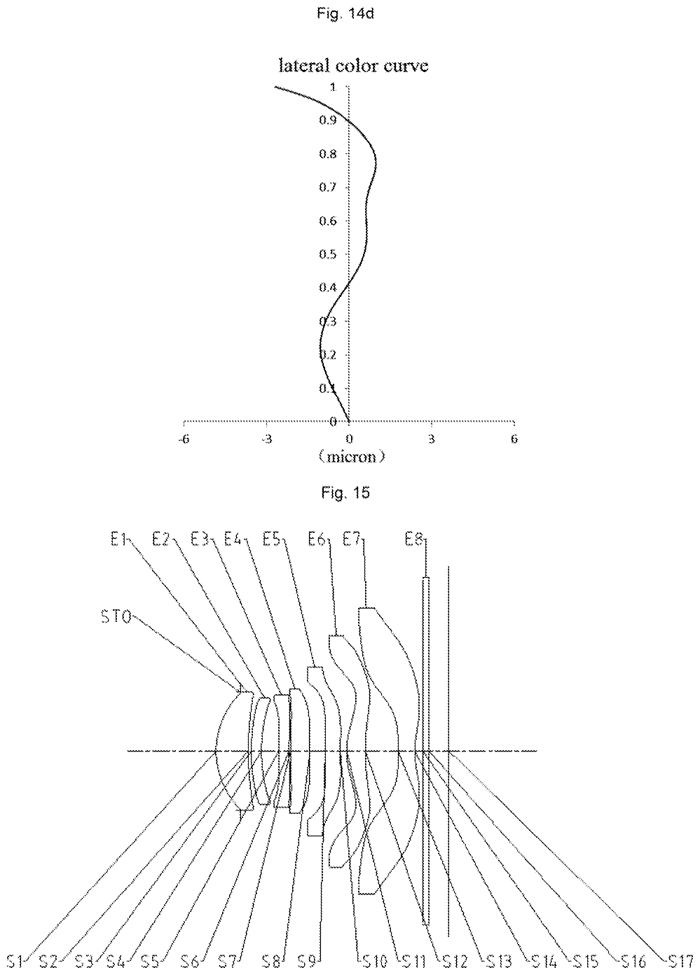

FIG. 14a shows a longitudinal aberration curve of the optical imaging camera lens assembly in Embodiment 7, which is the deviation of focus points of light with different wavelengths after passing through the camera lens. FIG. 14b shows an astigmatism curve of the optical imaging camera lens assembly in Embodiment 7, which is the curvature of a meridional image surface and the curvature of a sagittal image surface. FIG. 14c shows a distortion curve of the optical imaging camera lens assembly in Embodiment 7, which is distortion size values corresponding to different image heights. FIG. 14d shows a lateral color curve of the optical imaging camera lens assembly in Embodiment 7, which is the deviation of different image heights on the imaging plane after the light passes through the camera lens. It can be seen according to FIG. 14a to FIG. 14d that, the optical imaging camera lens assembly provided in Embodiment 7 can realize good imaging quality.

### Specific Embodiment 8

FIG. 15 is a schematic structural diagram of a lens group in Embodiment 8 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 22, it is a basic parameter table of the optical imaging camera lens assembly in Embodiment 8, wherein the units of curvature radius, thickness and focal length are all millimeters (mm).

TABLE 22

| | | | | | Material | | |
|---|---|---|---|---|---|---|---|
| Surface | Surface | Curvature | | Focal | Refractive | | Conic |
| number | type | radius | Thickness | length | index | Abbe number | coefficient |
| OBJ | Spherical | Infinite | 3000.0000 | | | | |
| STO | Spherical | Infinite | −0.8310 | | | | |
| S1 | Aspheric | 2.7710 | 1.0950 | 8.18 | 1.49 | 84.5 | −0.0373 |
| S2 | Aspheric | 7.9675 | 0.1043 | | | | −19.9019 |
| S3 | Aspheric | 5.6627 | 0.3502 | −164.21 | 1.66 | 20.4 | 3.2278 |
| S4 | Aspheric | 5.2508 | 0.5895 | | | | −2.2953 |
| S5 | Aspheric | 18.9516 | 0.3500 | −19.27 | 1.67 | 19.2 | −8.5797 |
| S6 | Aspheric | 7.6660 | 0.0511 | | | | −1.0000 |
| S7 | Aspheric | 11.7013 | 0.6647 | 18.96 | 1.54 | 56.1 | −59.4225 |
| S8 | Aspheric | −87.3198 | 0.5150 | | | | −9.2427 |
| S9 | Aspheric | 36.6384 | 0.5186 | −18.43 | 1.57 | 37.3 | 8.5640 |
| S10 | Aspheric | 8.1177 | 0.2145 | | | | −6.2773 |
| 511 | Aspheric | 2.4672 | 0.6429 | −5.71 | 1.54 | 56.1 | −4.5865 |
| S12 | Aspheric | 10.8056 | 1.1128 | | | | −2.1807 |
| S13 | Aspheric | 32.7488 | 0.5700 | −4.95 | 1.54 | 55.7 | 36.6857 |
| S14 | Aspheric | 2.4440 | 0.2796 | | | | −1.0542 |
| S15 | Spherical | Infinite | 0.2100 | | 1.52 | 64.2 | |
| S16 | Spherical | Infinite | 0.6820 | | | | |
| S17 | Spherical | Infinite | | | | | |

As shown in Table 23, in Embodiment 8, a total effective focal length f of the optical imaging camera lens assembly is 6.48 mm, TTL is a distance on the optical axis from the object-side surface S1 of the first lens E1 to the imaging surface S17 of the optical imaging camera lens assembly, TTL is 7.95 mm, and ImgH is a half of a diagonal length of an effective pixel region on the imaging surface S17, ImgH is 6.33 mm.

TABLE 23
Embodiment 8

| | | | |
|---|---|---|---|
| f(mm) | 6.48 | TTL(mm) | 7.95 |
| ImgH(mm) | 6.33 | ImgH * ImgH/TTL(mm) | 5.04 |
| V1 | 84.50 | TTL/ImgH | 1.26 |
| f * tan(FOV/2)(mm) | 6.19 | (R1 + R2)/f1 | 1.31 |
| (f4 + f6)/(f4 − f6) | 1.86 | f3/(R6 − R5) | 1.71 |
| f5/f7 | 3.72 | (R11 + R12)/(R13 + R14) | 0.38 |
| f12/f56 | 1.01 | (SAG51 + SAG52)/ | 0.91 |
| | | (SAG61 + SAG62) | |
| (SAG71 + SAG72)/T67 | −2.46 | (CT3 + ET3)/(CT4 + ET4) | 0.87 |
| (ET5 + ET6)/ET7 | 1.83 | | |

The optical imaging camera lens assembly in Embodiment 8 satisfies:

ImgH*ImgH/TTL=5.04, wherein ImgH is the half of the diagonal length of the effective pixel region on the imaging surface, and TTL is an on-axis distance from the object-side surface of the first lens to the imaging surface.

V1=84.50, wherein V1 is an Abbe number of the first lens.

TTL/ImgH=1.26, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.31, wherein R1 is a curvature radius of the object-side surface of the first lens, R2 is the curvature radius of the image-side surface of the first lens, and f1 is the effective focal length of the first lens.

(f4+f6)/(f4−f6)=1.86, wherein f4 is the effective focal length of the fourth lens, and f6 is the effective focal length of the sixth lens.

f3/(R6−R5)=1.71, wherein R6 is the curvature radius of the image-side surface of the third lens, R5 is the curvature radius of the object-side surface of the third lens, and f3 is the effective focal length of the third lens.

f5/f7=3.72, wherein f5 is the effective focal length of the fifth lens, and f7 is the effective focal length of the seventh lens.

(R11+R12)/(R13+R14)=0.38, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.01, wherein f12 is a combined focal length of the first lens and the second lens, and f56 is the combined focal length of the fifth lens and the sixth lens.

(SAG51+SAG52)/(SAG61+SAG62)=0.91, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.46, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.87, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.83, wherein ET5 is the edge thickness of the fifth lens, ET6 is the edge thickness of the sixth lens, and ET7 is the edge thickness of the seventh lens.

In Embodiment 8, the object-side surface and the image-side surface of any one of the first lens E1 to the seventh lens E7 are both aspheric surfaces, and Table 24 shows high-order coefficients A4, A6, A8, A10, A12, A14, A16, A18, A20, A22, A24, A26, A28 and A30 that can be applied to various aspheric lens surfaces S1-S14 in Embodiment 8.

TABLE 24

| Surface number | A4 | A6 | A8 | A10 | A12 | A14 | A16 |
|---|---|---|---|---|---|---|---|
| S1 | −1.0715E−03 | 2.7455E−03 | −3.7935E−03 | 3.3714E−03 | −1.9117E−03 | 6.8845E−04 | −1.5232E−04 |
| S2 | −1.0116E−02 | 3.8263E−03 | 3.6470E−03 | −6.0528E−03 | 4.3911E−03 | −1.8834E−03 | 4.8029E−04 |
| S3 | −2.1300E−02 | 1.7034E−02 | −5.7832E−02 | 1.8092E−01 | −3.5783E−01 | 4.7175E−01 | −4.3157E−01 |
| S4 | −5.9635E−03 | 2.8203E−03 | 9.6020E−03 | −6.4998E−02 | 2.1014E−01 | −4.0807E−01 | 5.1959E−01 |
| S5 | −3.6041E−02 | 9.2454E−02 | −3.8458E−01 | 1.0519E+00 | −1.9757E+00 | 2.6156E+00 | −2.4915E+00 |
| S6 | −4.2276E−02 | 4.0403 E−02 | −1.9391E−02 | −1.1939E−01 | 3.7436E−01 | −5.7854E−01 | 5.6573E−01 |
| S7 | −2.4726E−02 | 2.1686E−03 | 9.5208E−02 | −3.3319E−01 | 6.3158E−01 | −7.7387E−01 | 6.4939E−01 |
| S8 | −9.5867E−03 | −1.9665E−02 | 5.9469E−02 | −1.1446E−01 | 1.4910E−01 | −1.3798E−01 | 9.2850E−02 |
| S9 | −2.1056E−02 | 2.9025E−02 | −6.9218E−02 | 1.1931E−01 | −1.3764E−01 | 1.0851E−01 | −6.0422E−02 |
| S10 | −8.1548E−02 | 3.8679E−02 | −2.8080E−02 | 2.7056E−02 | −2.0572E−02 | 1.0662E−02 | −3.7975E−03 |
| S11 | −1.3189E−02 | −1.8314E−03 | 1.9401E−03 | −1.8682E−03 | 1.0852E−03 | −3.9350E−04 | 9.1086E−05 |
| S12 | 2.7015E−02 | −1.5609E−02 | 3.0558E−03 | −6.8933E−04 | 4.6312E−04 | −2.2349E−04 | 6.2883E−05 |
| S13 | −1.0692E−01 | 3.7261E−02 | −1.1523E−02 | 2.6162E−03 | −3.2659E−04 | 8.8786E−06 | 3.7297E−06 |
| S14 | −1.1379E−01 | 4.6136E−02 | −1.5996E−02 | 4.2064E−03 | −8.1242E−04 | 1.1570E−04 | −1.2242E−05 |
| Surface number | A18 | A20 | A22 | A24 | A26 | A28 | A30 |
| S1 | 1.8832E−05 | −1.0019E−06 | 0.0000E+00 | 0.0000E+00 | 0.0000E+00 | 0.0000E+00 | 0.0000E+00 |
| S2 | −6.6944E−05 | 3.9070E−06 | 0.0000E+00 | 0.0000E+00 | 0.0000E+00 | 0.0000E+00 | 0.0000E+00 |
| S3 | 2.7987E−01 | −1.2953E−01 | 4.2491E−02 | −9.6455E−03 | 1.4403E−03 | −1.2721E−04 | 5.0334E−06 |
| S4 | −4.5299E−01 | 2.7545E−01 | −1.1681E−01 | 3.3874E−02 | −6.4039E−03 | 7.1116E−04 | −3.5187E−05 |
| S5 | 1.7265E+00 | −8.7097E−01 | 3.1642E−01 | −8.0610E−02 | 1.3661E−02 | −13827E−03 | 6.3231E−05 |
| S6 | −3.7545E−01 | 1.7352E−01 | −5.5996E−02 | 1.2387E−02 | −1.7920E−03 | 1.5279E−04 | −5.8240E−06 |
| S7 | −3.8291E−01 | 1.6009E−01 | −4.7215E−02 | 9.6054E−03 | −1.2830E−03 | 1.0128E−04 | −3.5818E−06 |
| S8 | −4.5833E−02 | 1.6562E−02 | −4.3230E−03 | 7.9205E−04 | −9.6481E−05 | 7.0069E−06 | −2.2929E−07 |
| S9 | 2.4213E−02 | −7.0185E−03 | 1.4589E−03 | −2.1197E−04 | 2.0422E−05 | −1.1709E−06 | 3.0202E−08 |
| S10 | 9.4401E−04 | −1.6439E−04 | 1.9881E−05 | −1.6293E−06 | 8.5960E−08 | −2.6216E−09 | 3.4894E−11 |
| S11 | −1.3931E−05 | 1.4526E−06 | −1.0522E−07 | 5.3028E−09 | −1.8095E−10 | 3.8266E−12 | −3.8272E−14 |
| S12 | −1.1219E−05 | 1.3362E−06 | −1.0825E−07 | 5.9135E−09 | −2.0900E−10 | 4.3231E−12 | −3.9789E−14 |
| S13 | −6.7761E−07 | 6.1549E−08 | −3.5146E−09 | 1.3141E−10 | −3.1408E−12 | 4.3718E−14 | −2.7036E−16 |
| S14 | 9.6432E−07 | −5.6224E−08 | 2.3891E−09 | −7.1816E−11 | 1.4454E−12 | −1.7459E−14 | 9.5618E−17 |

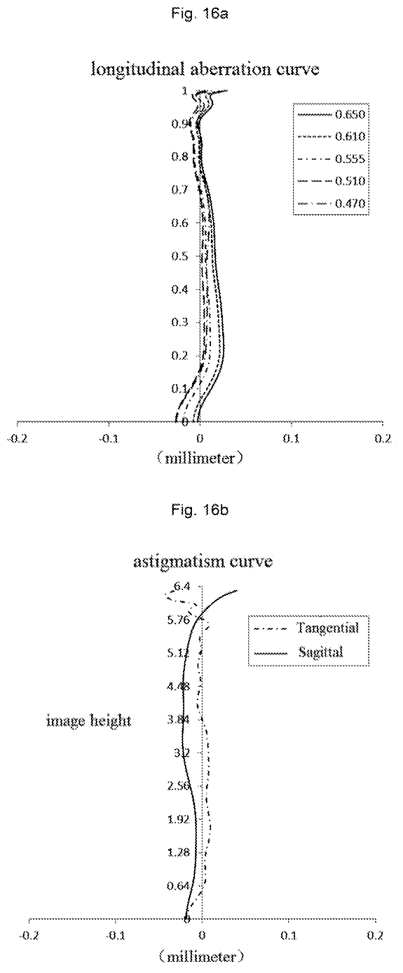

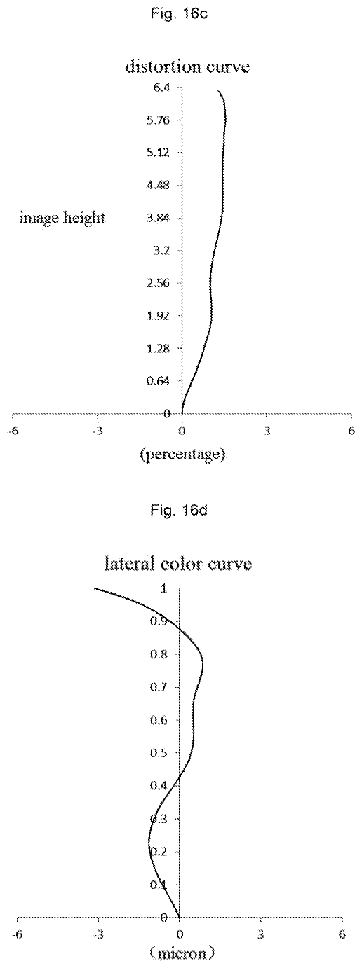

FIG. 16a shows a longitudinal aberration curve of the optical imaging camera lens assembly in Embodiment 8, which is the deviation of focus points of light with different wavelengths after passing through the camera lens. FIG. 16b shows an astigmatism curve of the optical imaging camera lens assembly in Embodiment 8, which is the curvature of a meridional image surface and the curvature of a sagittal image surface. FIG. 16c shows a distortion curve of the optical imaging camera lens assembly in Embodiment 8, which is distortion size values corresponding to different image heights. FIG. 16d shows a lateral color curve of the optical imaging camera lens assembly in Embodiment 8, which is the deviation of different image heights on the imaging plane after the light passes through the camera lens. It can be seen according to FIG. 16a to FIG. 16d that, the optical imaging camera lens assembly provided in Embodiment 8 can realize good imaging quality.

### Specific Embodiment 9

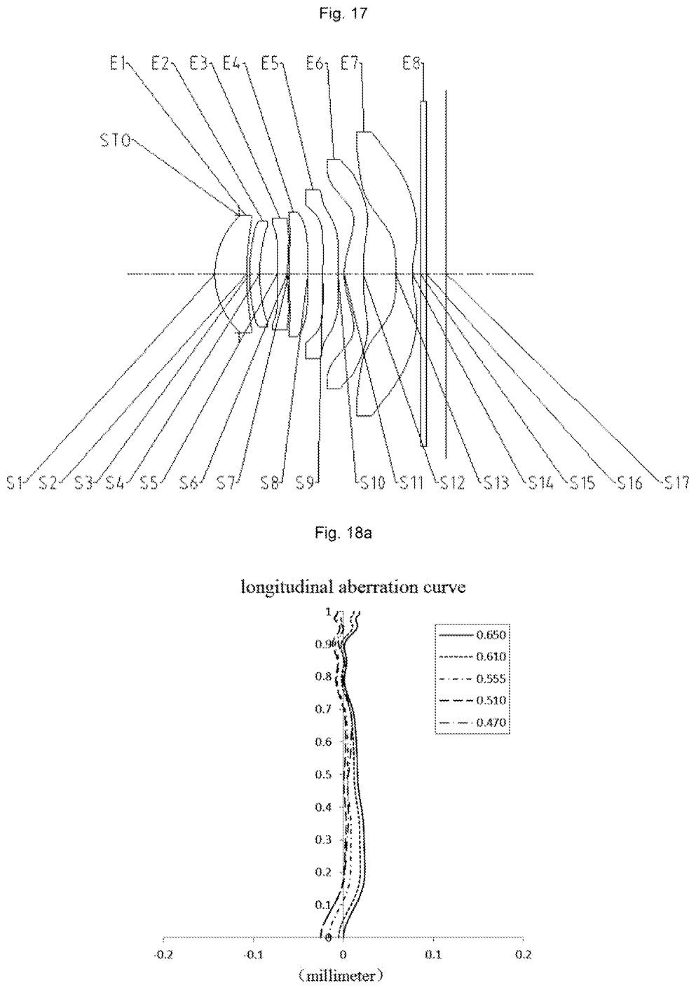

FIG. 17 is a schematic structural diagram of a lens group in Embodiment 9 of an optical imaging camera lens assembly according to the disclosure. The optical imaging camera lens assembly sequentially includes, from an object side to an image side along an optical axis: a diaphragm ST0, a first lens E1, a second lens E2, a third lens E3, a fourth lens E4, a fifth lens E5, a sixth lens E6, a seventh lens E7, an optical filter E8 and an imaging surface S17.

The first lens E1 has a positive refractive power, an object-side surface S1 thereof is a convex surface, and an image-side surface S2 thereof is a concave surface. The second lens E2 has a negative refractive power, the object-side surface S3 thereof is a convex surface, and the image-side surface S4 thereof is a concave surface. The third lens E3 has a negative refractive power, the object-side surface S5 thereof is a convex surface, and the image-side surface S6 thereof is a concave surface. The fourth lens E4 has a positive refractive power, the object-side surface S7 thereof is a convex surface, and the image-side surface S8 thereof is a convex surface. The fifth lens E5 has a negative refractive power, the object-side surface S9 thereof is a convex surface, and the image-side surface S10 thereof is a concave surface. The sixth lens E6 has a positive refractive power, the object-side surface S11 thereof is a convex surface, and the image-side surface S12 thereof is a concave surface. The seventh lens E7 has a negative refractive power, the object-side surface S13 thereof is a convex surface, and the image-side surface S14 thereof is a concave surface. The optical filter E8 has an object-side surface S15 and an image-side surface S16. The light from an object sequentially passes through the surfaces S1 to S16 and is finally imaged on the imaging surface S17.

As shown in Table 25, it is a basic parameter table of the optical imaging camera lens assembly in Embodiment 9, wherein the units of curvature radius, thickness and focal length are all millimeters (mm).

TABLE 25

| | | | | | Material | | |
|---|---|---|---|---|---|---|---|
| Surface | Surface | Curvature | | Focal | Refractive | Abbe | Conic |
| number | type | radius | Thickness | length | index | number | coefficient |
| OBJ | Spherical | Infinite | 3000.0000 | | | | |
| STO | Spherical | Infinite | −0.8357 | | | | |
| S1 | Aspheric | 2.7599 | 1.0950 | 8.37 | 1.48 | 86.0 | −0.0383 |
| S2 | Aspheric | 7.8331 | 0.0945 | | | | −18.7087 |
| S3 | Aspheric | 5.4530 | 0.3500 | −359.42 | 1.66 | 18.4 | 3.1250 |
| S4 | Aspheric | 5.1957 | 0.6015 | | | | −2.6415 |
| S5 | Aspheric | 18.3665 | 0.3500 | −18.82 | 1.67 | 19.2 | −0.2430 |
| S6 | Aspheric | 7.4617 | 0.0500 | | | | −99.0000 |
| S7 | Aspheric | 10.8097 | 0.6529 | 19.07 | 1.54 | 56.1 | −55.5525 |
| S8 | Aspheric | −269.4339 | 0.5150 | | | | 90.0000 |
| S9 | Aspheric | 31.5319 | 0.5201 | −17.45 | 1.57 | 37.3 | 43.6629 |
| S10 | Aspheric | 7.5101 | 0.2142 | | | | −6.9590 |
| 511 | Aspheric | 2.4360 | 0.6505 | 5.56 | 1.54 | 56.1 | −4.5432 |
| S12 | Aspheric | 11.1997 | 1.1149 | | | | −1.2258 |
| S13 | Aspheric | 30.5525 | 0.5700 | −4.94 | 1.54 | 55.7 | 31.6622 |
| S14 | Aspheric | 2.4229 | 0.2796 | | | | −1.0578 |
| S15 | Spherical | Infinite | 0.2100 | | 1.52 | 64.2 | |
| S16 | Spherical | Infinite | 0.6820 | | | | |
| S17 | Spherical | Infinite | | | | | |

As shown in Table 26, in Embodiment 9, a total effective focal length f of the optical imaging camera lens assembly is 6.48 mm, TTL is a distance on the optical axis from the object-side surface S1 of the first lens E1 to the imaging surface S17 of the optical imaging camera lens assembly, TTL is 7.95 mm, and ImgH is a half of a diagonal length of an effective pixel region on the imaging surface S17, ImgH is 6.33 mm.

TABLE 26
Embodiment 9

| | | | |
|---|---|---|---|
| f(mm) | 6.48 | TTL(mm) | 7.95 |
| ImgH(mm) | 6.33 | ImgH * ImgH/TTL(mm) | 5.04 |
| V1 | 86.00 | TTL/ImgH | 1.26 |
| f * tan(FOV/2)(mm) | 6.19 | (R1 + R2)/f1 | 1.27 |
| (f4 + f6)/(f4 − f6) | 1.82 | f3/(R6 − R5) | 1.73 |
| f5/f7 | 3.53 | (R11 + R12)/(R13 + R14) | 0.41 |
| f12/f56 | 1.02 | (SAG51 + SAG52)/ | 0.88 |
| | | (SAG61 + SAG62) | |
| (SAG71 + SAG72)/T67 | −2.47 | (CT3 + ET3)/(CT4 + ET4) | 0.88 |
| (ET5 + ET6)/ET7 | 1.83 | | |

The optical imaging camera lens assembly in Embodiment 9 satisfies:

ImgH*ImgH/TTL=5.04, wherein ImgH is the half of the diagonal length of the effective pixel region on the imaging surface, and TTL is an on-axis distance from the object-side surface of the first lens to the imaging surface.

V1=86.00, wherein V1 is an Abbe number of the first lens.

TTL/ImgH=1.26, wherein TTL is the on-axis distance from the object-side surface of the first lens to the imaging surface, and ImgH is the half of the diagonal length of the effective pixel region on the imaging surface.

f*tan (FOV/2)=6.19, wherein f is an effective focal length of the optical imaging camera lens assembly, and FOV is a maximum field of view of the optical imaging camera lens assembly.

(R1+R2)/f1=1.27, wherein R1 is a curvature radius of the object-side surface of the first lens, R2 is the curvature radius of the image-side surface of the first lens, and f1 is the effective focal length of the first lens.

(f4+f6)/(f4−f6)=1.82, wherein f4 is the effective focal length of the fourth lens, and f6 is the effective focal length of the sixth lens.

f3/(R6−R5)=1.73, wherein R6 is the curvature radius of the image-side surface of the third lens, R5 is the curvature radius of the object-side surface of the third lens, and f3 is the effective focal length of the third lens.

f5/f7=3.53, wherein f5 is the effective focal length of the fifth lens, and f7 is the effective focal length of the seventh lens.

(R11+R12)/(R13+R14)=0.41, wherein R11 is the curvature radius of the object-side surface of the sixth lens, R12 is the curvature radius of the image-side surface of the sixth lens, R13 is the curvature radius of the object-side surface of the seventh lens, and R14 is the curvature radius of the image-side surface of the seventh lens.

f12/f56=1.02, wherein f12 is a combined focal length of the first lens and the second lens, and f56 is the combined focal length of the fifth lens and the sixth lens.

(SAG51+SAG52)/(SAG61+SAG62)=0.88, wherein SAG51 is the on-axis distance from an intersection point of the object-side surface of the fifth lens and the optical axis to an effective radius vertex of the object-side surface of the fifth lens, SAG52 is the on-axis distance from the intersection point of the image-side surface of the fifth lens and the optical axis to the effective radius vertex of the image-side surface of the fifth lens, SAG61 is the on-axis distance from the intersection point of the object-side surface of the sixth lens and the optical axis to the effective radius vertex of the object-side surface of the sixth lens, and SAG62 is the on-axis distance from the intersection point of the image-side surface of the sixth lens and the optical axis to the effective radius vertex of the image-side surface of the sixth lens.

(SAG71+SAG72)/T67=−2.47, wherein SAG71 is the on-axis distance from the intersection point of the object-side surface of the seventh lens and the optical axis to the effective radius vertex of the object-side surface of the seventh lens, SAG72 is the on-axis distance from the intersection point of the image-side surface of the seventh lens and the optical axis to the effective radius vertex of the image-side surface of the seventh lens, and T67 is an air spacing between the sixth lens and the seventh lens on the optical axis.

(CT3+ET3)/(CT4+ET4)=0.88, wherein CT3 is a center thickness of the third lens on the optical axis, ET3 is an edge thickness of the third lens, CT4 is the center thickness of the fourth lens on the optical axis, and ET4 is the edge thickness of the fourth lens.

(ET5+ET6)/ET7=1.83, wherein ET5 is the edge thickness of the fifth lens, ET6 is the edge thickness of the sixth lens, and ET7 is the edge thickness of the seventh lens.

In Embodiment 9, the object-side surface and the image-side surface of any one of the first lens E1 to the seventh lens E7 are both aspheric surfaces, and Table 27 shows high-order coefficients A4, A6, A8, A10, A12, A14, A16, A18, A20, A22, A24, A26, A28 and A30 that can be applied to various aspheric lens surfaces S1-S14 in Embodiment 9.

TABLE 27

| Surface number | A4 | A6 | A8 | A10 | A12 | A14 | A16 |
|---|---|---|---|---|---|---|---|
| S1 | −1.1889E−03 | 3.0604E−03 | −4.2984E−03 | 3.9581E−03 | −2.3603E−03 | 8.9865E−04 | −2.0983E−04 |
| S2 | −9.8217E−03 | 4.4002E−03 | 1.5664E−03 | −3.0823E−03 | 2.0588E−03 | −8.0653E−04 | 1.8830E−04 |
| S3 | −2.0190E−02 | 2.2590E−02 | −9.5043E−02 | 3.0130E−01 | −6.0465E−01 | 8.1308E−01 | −7.6084E−01 |
| S4 | −4.7440E−03 | 3.4741E−03 | 9.0815E−03 | −8.1286E−02 | 2.7344E−01 | −5.3220E−01 | 6.7368E−01 |
| S5 | −3.5271E−02 | 9.0896E−02 | −3.7628E−01 | 1.0275E+00 | −1.9345E+00 | 2.5725E+00 | −2.4641E+00 |
| S6 | −1.3862E−02 | 1.1657E−02 | 3.6444E−02 | −2.2773E−01 | 5.2831E−01 | −7.3291E−01 | 6.7649E−01 |
| S7 | −2.5323E−02 | −3.3699E−03 | 1.2227E−01 | −3.8461E−01 | 6.8392E−01 | −7.9985E−01 | 6.4780E−01 |
| S8 | −1.0045E−02 | −1.7357E−02 | 5.2493E−02 | −1.0124E−01 | 1.3256E−01 | −1.2335E−01 | 8.3378E−02 |
| S9 | −1.9909E−02 | 2.3107E−02 | −5.5000E−02 | 9.9715E−02 | −1.1996E−01 | 9.7574E−02 | −5.5693E−02 |
| S10 | −8.3459E−02 | 3.9444E−02 | −2.5012E−02 | 2.1348E−02 | −1.5337E−02 | 7.5989E−03 | −2.5677E−03 |
| S11 | −1.5277E−02 | 1.0443E−03 | −1.2557E−05 | −8.1920E−04 | 6.0866E−04 | −2.2645E−04 | 4.8337E−05 |
| S12 | 2.6738E−02 | −1.5892E−02 | 4.1994E−03 | −1.6331E−03 | 8.8647E−04 | −3.4857E−04 | 8.8914E−05 |
| S13 | −1.0913E−01 | 3.8000E−02 | −1.1440E−02 | 2.4382E−03 | −2.4962E−04 | −9.6893E−06 | 6.6291E−06 |
| S14 | −1.1552E−01 | 4.6756E−02 | −1.6048E−02 | 4.1695E−03 | −7.9663E−04 | 1.1250E−04 | −1.1835E−05 |
| Surface number | A18 | A20 | A22 | A24 | A26 | A28 | A30 |
| S1 | 2.7233E−05 | −1.5076E−06 | 0.0000E+00 | 0.0000E+00 | 0.0000E+00 | 0.0000E+00 | 0.0000E+00 |
| S2 | −2.3791E−05 | 1.2164E−06 | 0.0000E+00 | 0.0000E+00 | 0.0000E+00 | 0.0000E+00 | 0.0000E+00 |
| S3 | 5.0547E−01 | −2.3993E−01 | 8.0789E−02 | −1.8842E−02 | 2.8932E−03 | −2.6306E−04 | 1.0726E−05 |
| S4 | −5.8305E−01 | 3.5212E−01 | −1.4845E−01 | 4.2842E−02 | −8.0687E−03 | 8.9346E−04 | −4.4117E−05 |
| S5 | 1.7179E+00 | −8.7203E−01 | 3.1871E−01 | −8.1644E−02 | 1.3905E−02 | −1.4134E−03 | 6.4855E−05 |
| S6 | −4.3318E−01 | 1.9550E−01 | −6.2057E−02 | 1.3569E−02 | −1.9463E−03 | 1.6490E−04 | −6.2560E−06 |
| S7 | −3.7161E−01 | 1.5204E−01 | −4.4068E−02 | 8.8387E−03 | −1.1667E−03 | 9.1180E−05 | −3.1971E−06 |
| S8 | −4.1270E−02 | 1.4929E−02 | −3.8963E−03 | 7.1322E−04 | −8.6770E−05 | 6.2938E−06 | −2.0574E−07 |
| S9 | 2.2787E−02 | −6.7256E−03 | 1.4205E−03 | −2.0933E−04 | 2.0421E−05 | −1.1837E−06 | 3.0820E−08 |
| S10 | 5.9601E−04 | −9.4566E−05 | 1.0028E−05 | −6.7480E−07 | 2.5597E−08 | −3.7896E−10 | −2.2163E−12 |
| S11 | −6.1056E−06 | 4.3878E−07 | −1.3592E−08 | −3.2524E−10 | 4.2377E−H | −1.3255E−12 | 1.4115E−14 |
| S12 | −1.5120E−05 | 1.7582E−06 | −1.4081E−07 | 7.6578E−09 | −2.7058E−10 | 5.6100E−12 | −5.1841E−14 |
| S13 | −9.8759E−07 | 8.4765E−08 | −4.7349E−09 | 1.7559E−10 | −4.1912E−12 | 5.8501E−14 | −3.6372E−16 |
| S14 | 9.2892E−07 | −5.4072E−08 | 2.2975E−09 | −6.9136E−11 | 1.3943E−12 | −1.6888E−14 | 9.2804E−17 |

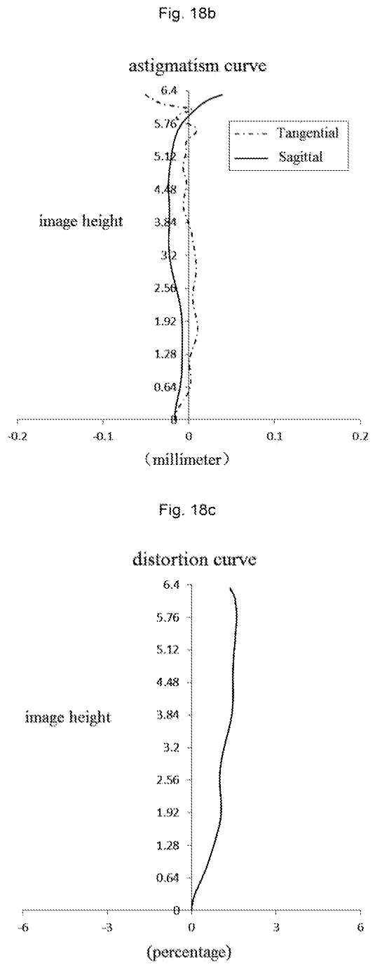

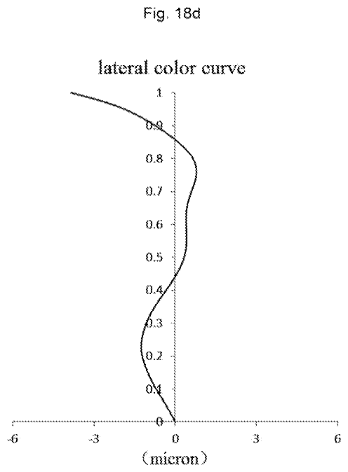

FIG. 18a shows a longitudinal aberration curve of the optical imaging camera lens assembly in Embodiment 9, which is the deviation of focus points of light with different wavelengths after passing through the camera lens. FIG. 18b shows an astigmatism curve of the optical imaging camera lens assembly in Embodiment 9, which is the curvature of a meridional image surface and the curvature of a sagittal image surface. FIG. 18c shows a distortion curve of the optical imaging camera lens assembly in Embodiment 9, which is distortion size values corresponding to different image heights. FIG. 18d shows a lateral color curve of the optical imaging camera lens assembly in Embodiment 9, which is the deviation of different image heights on the imaging plane after the light passes through the camera lens. It can be seen according to FIG. 18a to FIG. 18d that, the optical imaging camera lens assembly provided in Embodiment 9 can realize good imaging quality.

The foregoing descriptions are merely preferred embodiments of the disclosure, and are not intended to limit the disclosure. Any modifications, improvements, equivalent replacements and the like, made within the spirit and principles of the disclosure, shall all fall within the protection scope of the disclosure.

What is claimed is:

1. An optical imaging camera lens assembly, sequentially comprising, from an object side to an image side along an optical axis:
a first lens having a positive refractive power;
a second lens, an object-side surface thereof being a convex surface, and an image-side surface thereof being a concave surface;
a third lens having a negative refractive power, and an object-side surface thereof being a convex surface;
a fourth lens;
a fifth lens having a negative refractive power;
a sixth lens having a positive refractive power; and
a seventh lens having a negative refractive power,
wherein ImgH is a half of a diagonal length of an effective pixel region on an imaging surface, and TTL is an on-axis distance from an object-side surface of the first lens to the imaging surface, ImgH and TTL satisfy: 4.8 mm<ImgH*ImgH/TTL<7.0 mm; and an Abbe number V1 of the first lens satisfies: 70<V1<90.

2. The optical imaging camera lens assembly according to claim 1, wherein ImgH and TTL satisfy: TTL/ImgH<1.3.

3. The optical imaging camera lens assembly according to claim 1, wherein FOV is a maximum field of view of the optical imaging camera lens assembly, an effective focal length f of the optical imaging camera lens assembly and FOV satisfy: 5.5 mm<f*tan (FOV/2)<6.5 mm.

4. The optical imaging camera lens assembly according to claim 1, wherein a curvature radius R1 of an object-side surface of the first lens, a curvature radius R2 of an image-side surface of the first lens, and an effective focal length f1 of the first lens satisfy: 1.0<(R1+R2)/f1<1.5.

5. The optical imaging camera lens assembly according to claim 1, wherein an effective focal length f4 of the fourth lens and an effective focal length f6 of the sixth lens satisfy: 1.5<(f4+f6)/(f4−f6)<2.0.

6. The optical imaging camera lens assembly according to claim 1, wherein the curvature radius R6 of an image-side surface of the third lens, the curvature radius R5 of the object-side surface of the third lens, and an effective focal length f3 of the third lens satisfy: 1.6<f3/(R6−R5)<4.2.

7. The optical imaging camera lens assembly according to claim 1, wherein an effective focal length f5 of the fifth lens and an effective focal length f7 of the seventh lens satisfy: 2.5<f5/f7<4.6.

8. The optical imaging camera lens assembly according to claim 1, wherein a curvature radius R11 of an object-side surface of the sixth lens, a curvature radius R12 of an image-side surface of the sixth lens, a curvature radius R13 of an object-side surface of the seventh lens, and a curvature radius R14 of an image-side surface of the seventh lens satisfy: 0<(R11+R12)/(R13+R14)<1.5.

9. The optical imaging camera lens assembly according to claim 1, wherein a combined focal length f12 of the first lens and the second lens, and a combined focal length f56 of the fifth lens and the sixth lens satisfy: 0.7<f12/f56<1.2.

10. The optical imaging camera lens assembly according to claim 1, wherein an on-axis distance SAG51 from an intersection point of an object-side surface of the fifth lens and the optical axis to an effective radius vertex of the object-side surface of the fifth lens, an on-axis distance SAG52 from the intersection point of an image-side surface of the fifth lens and the optical axis to the effective radius vertex of the image-side surface of the fifth lens, an on-axis distance SAG61 from the intersection point of an object-side surface of the sixth lens and the optical axis to the effective radius vertex of the object-side surface of the sixth lens, and an on-axis distance SAG62 from the intersection point of the image-side surface of the sixth lens and the optical axis to the effective radius vertex of the image-side surface of the sixth lens satisfy: 0.7<(SAG51+SAG52)/(SAG61+SAG62)<1.2.

11. The optical imaging camera lens assembly according to claim 1, wherein an on-axis distance SAG71 from the intersection point of an object-side surface of the seventh lens and the optical axis to the effective radius vertex of the object-side surface of the seventh lens, an on-axis distance SAG72 from the intersection point of an image-side surface of the seventh lens and the optical axis to the effective radius vertex of the image-side surface of the seventh lens, and an air spacing T67 between the sixth lens and the seventh lens on the optical axis satisfy: −2.7<(SAG71+SAG72)/T67<−2.2.

12. The optical imaging camera lens assembly according to claim 1, wherein a center thickness CT3 of the third lens on the optical axis, an edge thickness ET3 of the third lens, a center thickness CT4 of the fourth lens on the optical axis, and an edge thickness ET4 of the fourth lens satisfy: 0.7<(CT3+ET3)/(CT4+ET4)<1.1.

13. The optical imaging camera lens assembly according to claim 1, wherein an edge thickness ET5 of the fifth lens, an edge thickness ET6 of the sixth lens, and an edge thickness ET7 of the seventh lens satisfy: 1.6<(ET5+ET6)/ET7<2.1.
